(19) United States
(12) Patent Application Publication
(10) Pub. No.: US 2013/0281897 A1
(43) Pub. Date: Oct. 24, 2013

(54) Non-invasive reperfusion system by deformation of remote, superficial arteries at a frequency much greater than the pulse rate

(71) Applicants: Andrew Kenneth Hoffmann, Burnaby (CA); Harjit Kaur Gill-Hoffmann, Burnaby (CA)

(72) Inventors: Andrew Kenneth Hoffmann, Burnaby (CA); Harjit Kaur Gill-Hoffmann, Burnaby (CA)

(73) Assignee: Ahof Biophysical Systems Inc., Burnaby (CA)

(21) Appl. No.: 13/986,252

(22) Filed: Apr. 17, 2013

Related U.S. Application Data
(63) Continuation-in-part of application No. 12/798,437, filed on Apr. 5, 2010.
Application No. 12/798,437 is a continuation-in-part of application No. 12/291,128, filed on Nov. 5, 2008.
Application No. 12/291,128 is a continuation-in-part of application No. 12/218,054, filed on Jul. 11, 2008.
Application No. 12/218,054 is a continuation-in-part of application No. 11/036,386, filed on Jan. 18, 2005, now abandoned.
Application No. 11/036,386 is a continuation-in-part of application No. 10/902,122, filed on Jul. 30, 2004, now Pat. No. 7,517,328.

(30) Foreign Application Priority Data
Sep. 4, 2003 (CA) 2439667 A1

(51) Int. Cl. A61H 23/00

(52) U.S. Cl. CPC A61H 23/00
USPC 601/107

(57) ABSTRACT

Preferred systems for assisting clearance of an acutely thrombosed artery substantially surrounded by boney external body surfaces which are resistant to deformative displacement relative to the thrombosed artery by the application of external percussive force are described. The method consists of applying targeted, localized, non-invasive, high infrasonic to low sonic frequency vibratory percussion with a serial impact frequency much greater than the pulse rate of a patient being treated, the percussion directed towards a remote, preferably superficial “target vessel” residing palpably close to the skin surface. Marked vessel deformations with resultant blood pressure and flow fluctuations are thereby induced by the percussion within the target vessel which propagate to the acutely thrombosed artery to provide localized agitation and turbulence to assist thrombolytic and/or IV microbubble delivery and effectiveness in facilitating reperfusion. Preferred apparatus for treatment of ST elevation myocardial infarction, acute ischemic stroke and acute pulmonary embolus are presented.

### CLAIM OF PRIORITY

The present application is a continuation in part and claims priority to co-pending U.S. patent application Ser. No. 12/798,437 filed Apr. 5, 2010 which claims priority to U.S. patent application Ser. No. 12/291,128 filed Feb. 5, 2008 which claims priority to U.S. patent application Ser. No. 12/218,054 filed on Jul. 11, 2008 which claims priority to U.S. patent application Ser. No. 11/036, 386 filed on Jan. 18, 2005 which claims priority to U.S. Pat. No. 7,517,328 filed Jul. 30, 2004, which claims priority to Canadian Patent Application No. 2439667 A1 filed Sep. 4, 2003. The contents of these applications are incorporated herein by reference in their entirety.

### FIELD OF THE INVENTION

This invention relates to noninvasive emergency medical systems for imparting transcutaneous mechanical vibration in the infrasonic to low sonic frequency ranges to improve first line clearance of acute, life threatening thrombotic arterial occlusions such as in heart attack or stroke. This system is also related to methods for assisting delivery of intravenous thrombolytic drug therapy and/or acoustically active IV microbubbles.

### BACKGROUND OF THE INVENTION

Acute arterial thrombosis is a common and major medical concern. Thrombo-occlusive cardiovascular disease subsequent to coronary arterial thrombosis (heart attack) is the leading cause of death in North America and Europe, and Acute Ischemic Stroke (AIS) subsequent to acute cerebral arterial thrombosis is the third leading cause of death, and a leading cause of serious disability.

In the case of ST elevation Acute Myocardial Infarction (STEMI), the most serious form of heart attack, the preferred treatment when a cardiac cath-lab is reachable within 90 minutes is Primary Percutaneous Coronary Intervention (PPCI) where the acutely thrombosed coronary is opened with a balloon and a stent. However a disadvantage of such invasive treatment (while very successful) is that substantial infrastructure is required which is not readily accessible in many hospitals world-wide, and even when available there is often a significant time delay in delivering the patient which is often by inter-hospital transfer. These difficulties result in a delay in treatment (often greater than 90 minutes) with increased myocardial necrosis with poorer clinical outcomes, and a reduction in likelihood of a successful and timely reperfusion.

For these reasons intravenously (IV) administered thrombolytic drug therapy (where a clot busting drug is used to dissolve the acute thrombosis), despite slow and incomplete reperfusion rates and increased risks for intra-cerebral hemorrhage remains a common sub-optimal alternative therapy for STEMI treatment worldwide, with the drug typically delivered in ambulance en-route to hospital (i.e. “pre-hospital thrombolysis”).

In the case of AIS there are similarly a lack of invasive neurological special procedure units enabling preferred direct catheter delivered procedures (such as intra-arterial thrombolysis where a clot busting drug is delivered directly to the clot). Hence again systemically delivered IV thrombolysis (which even more so struggles with slow and incomplete reperfusion) remains the standard therapy option in most centers throughout North America and Europe.

Non-invasive treatment systems utilizing noninvasive Low Frequency UltraSound (i.e. “LFUS” e.g. 20 kHz-300 kHz) targeted over a thrombosis site have been employed as an adjunct to IV thrombolysis, including coronary and cerebral thrombolysis, in attempting to overcome these disadvantages. The LFUS wave form provides mechanical agitation via cavitation, acoustic streaming and increased sheer stresses to the blood within the culprit vasculature wherein a blood clot resides, thereby encouraging disruption of the clot and increased permeation of the drug into the clot to accelerate reperfusion.

LFUS applied transthoracically (via a unit placed over the chest wall) has however failed to show efficacy in assisting coronary reperfusion in treatment of STEMI (i.e. the PLUS study—27 kHz), likely because the heart and coronary arteries are acoustically shielded from ultrasound from a thick overlying chest wall and lung which does not transmit ultrasound. Also, LFUS at too high an intensity is known to burn the overlying skin of a patient, and has been shown in some experiments to actually induce clotting and damage blood vessels. Some researchers are hopeful that chest wall directed High Frequency diagnostic UltraSound (HFUS) may yet prove useful in STEMI treatment (i.e. Sonolysis Study—1.6 MHz, results pending) if the HFUS beam is targeted to the aortic root by a skill based 3D ultrasonic imaging procedure along with IV micro-bubble administration (whereby HFUS, set at a high mechanical index or power level shakes and breaks apart the bubbles while proximate the heart leading to an enhanced agitative cavitation effect). However this technique (even if it were to work) requires a highly skilled based procedure by a cardiac sonographer to direct and maintain the ultrasound administration which would rarely be available in the field to affect a first line response. Moreover, it is unlikely that systemically delivered micro-bubbles would reach to any significant degree the blocked, culprit coronary artery (as the artery has no flow), which casts serious doubts on the prospective success of this technique.

LFUS applied transcranially (i.e. via a helmet mechanism) has also proven in-effective in treatment of AIS, with a recent clinical study (i.e. TRUMBI trial—300 KHz), showing dangerous intra-cerebral bleeding hence requiring the trial to be discontinued. TransCranial Doppler (TCD)—a skilled lower power level transcranial diagnostic HFUS imaging procedure in the MHz ranges—has on the other hand reported some preliminary success in accelerating cerebral IV thrombolysis in small numbers, particularly when applied in co-ordination with IV micro-bubbles, however again there is no assurance (and no physiologic reason to suspect) that the micro-bubbles would to any significant degree reach the blocked cerebral artery. TCD also requires a highly skilled approach by a sonographer (a difficult procedure with the ultrasound applied through tiny fissures in the scalp—impractical for emergency scenarios), and furthermore there are experimental reports that TCD does not even prospectively carry enough power to enhance thrombolysis when emitted through the bones of the cranium. More recent small clinical trials involving transcranial HFUS applied at a higher power levels is again trending towards significant bleeding risks hence casting serious doubts on the prospective use and adoption of this therapy, or its potential success in larger clinical trials.

Lithotriptic style techniques such as in U.S. Pat. Nos. 5,065,741, 5,207,214, 5,524,620, 5,613,940, 5,725,482, 6,068,596 and U.S. patent application Ser. No. 2004/0006288 A1 (which employ use of externally imparted focused ultrasonic waves or ultrasonic shock waves directed by an imaging modality to directly strike an internal target including thromboses) have also been disclosed. This style of therapy (while common in the treatment of kidney stones and the like) has not gained acceptance in the emergency treatment of acute vascular obstructions or thrombotic obstructions, probably because thrombotic lesions are difficult (if not impossible) to conveniently image, and these style of applications are inexpedient for use as they require advanced training, a controlled environment, calculations, and specialized equipment to employ. Furthermore, lithotriptic systems and other focused wave therapy techniques are generally limited to treatment of stationary targets within the human body, hence applications to the coronary arteries (such as in the acute treatment of coronary thrombotic lesions) cannot prospectively be performed.

Mechanical vibration treatment systems in the lower infrasonic to sonic ranges have been considered in the invasive treatment of thrombotic occlusions via catheter based techniques. U.S. Pat. No. 6,287,271 to Dubrul et al., for example, discloses a low-frequency (1-1000 Hz) vibrating catheter drug delivery system resulting in 68% lysing when placed proximally to an artificial clot in a test tube with the drug Urokinase, versus 4.5% lysing with Urokinase treatment alone. As stated above, this system is invasive, and thereby requiring great specialized skill and equipment to introduce a catheter directly to the thrombosis site, and thus has no utility as a first line measure in the field or in emergency room cases.

Generally however, non-invasively delivered vibration techniques within the infrasonic to low sonic frequency range (e.g. 1 Hz to 1000 Hz) has received little focus in the field of treatment of acute vascular occlusions.

Cardio Pulmonary Resuscitation (“CPR”), which is essentially repetitive high displacement amplitude compression wave energy of 1.5 Hz (to approximate compressions at a patient's heart rate) was paired successfully in conjunction with coronary thrombolysis in cases of known acute myocardial infarction where the patient had deteriorated to cardiac arrest and hence poor outcome was otherwise imminent. These cases were reported by Tiffany et al. in “Bolus Thrombolytic Infusions During CPR for Patients With Refractory Arrest Rhythms: Outcome of a Case Series” (Annals of Emergency Medicine, 31:1, January 1998, 134-136). This medical method, which was designed to sustain the life of the patient conjointly with the deliverance of thrombolysis (and not to act as an adjunct to thrombolysis per se), is limited to cardiac arrest situations, and the manual nature of the application of high displacement amplitude, mechanical energy to the chest wall by human hand would be labor intensive, potentially tiresome to an operator, and would quickly cause undue harm to a patient if delivered for sustained periods. Moreover a more recent large clinical trial assessing the pairing of IV thrombolysis with CPR (i.e. TROICA trial) ended in futility, in that the benefit of the combination could not be statistically proven.

Sackner in U.S. patent application No. 2002083454 discloses a “reciprocating movement platform” or bed which oscillates in a to and fro motion (i.e. in the head to foot direction), delivering “external pulses” to a human body in the frequency range of 0.25-6 Hz, for a plurality of applications including improving blood circulation in chronic and acute cases. The '454 patent application invokes hemodynamic forces or “pulses” by virtue of the accelerations and deceleration's of the movement platform which purportedly instill sheer stresses from blood to endothelium of the vasculature, which is known to invoke the liberation of endogenous “beneficial mediators” such as t-PA, EDRF, and Nitric Oxide (all of which are of assistance in the improvement of blood flow and prophylaxis to disease). Whole body shaking methods such as Sackner describes are not well suited for treatment of acute thrombotic lesions or emergency blood flow disturbances as relatively small (or insignificant) localized forces to the targeted vascular regions themselves are generated. Furthermore, the oscillations emitted are lower than the resonance frequency of the epi-mycardium within the thoracic cavity, hence the vibratory effect reaching the heart (and coronaries) would be even further diminished in cardiac applications. Finally the treatment method invariably also aggressively shakes the patient's head which is potentially dangerous and inappropriate if the treatment system where ever to be used conjointly with thrombolytic therapy in STEMI cases (due to increased risks of intra-cerebral hemorrhage).

Enhanced External Counter-Pulsation (EECP) with leg squeezers periodically inflated and then deflated in co-ordination with the diastolic phase of the cardiac cycle of a patient (i.e. to match the patient's intrinsic pulse rate) have found use in clinics for treatment of chronic angina. EECP induces periodic compressions to a patient's legs and thighs which in turn compress the leg arteries to send pressure pulses retrograde to the coronary vasculature to enhance diastolic coronary blood flow—and purportedly induce (by introduction of coronary sheer stresses) growth of new coronary vessels. This technique would not be well suited to emergency STEMI (or AIS) situations as the squeezing is administered at much too low a frequency (typically one inflation/deflation cycle per second) and is applied unnecessarily far distant from the vasculature of the heart or brain hence severely limiting the waveforms energy and propagative capability to assist clearance of an acutely thrombosed (or cerebral arterial) vessel. This technique is also not portable and very cumbersome to use (hence not expedient for use in an emergency procedure—particularly if delivered in the field or ambulance), and thereby has found no utility in treatment of acute vascular disease or thrombosis.

Similar to EECP, Intermittent Pneumatic Compression (IPC) is another technology involving periodic leg squeezing, which is in this case utilized for prophylaxis against Deep Vein Thrombosis (DVT) and to assist chronic arterial perfusion in patients with Peripheral Vascular Disease (PVD). This technique generally requires greater than one second (and usually several seconds, or in some applications even greater than a minute) for the cuffs to inflate, so again like EECP, the compressions to the arteries provided are at far too low a frequency (generally much lower than a patient's pulse rate) and applied at a non-preferably far distance from the heart (or brain) to provide any significant upstream agitative, clot disruptive effects which may be helpful in clearing acute thrombosis such as in STEMI or AIS.

Koiwa in Jap. Pat. No. JP 8,089,549 (“549”) discloses a noninvasive 50 Hz diastolic timed chest wall vibrator treatment system via a singular mechanical probe to rib-space coupling interface to increase cardiac output in treatment of cardiomyopathy. The '549 patent increases coronary blood flow to stable patients with known coronary artery narrowings as a means for treating heart failure, through a prescribed method of applying vibration specifically timed to the diastolic phase of the cardiac cycle via a hand held unit applied to the chest wall. Koiwa teaches that diastolic timed vibration relaxes the myocardium (which is particularly stiff in ischemic states), allowing it to perfuse and, by Starling's law, pump more efficiently.

The '549 patent is not directed to the treatment of emergent coronary incidents or acute thrombotic events, hence there are inherent limitations to the disclosed system. For example, the disclosed single probe to single rib-space coupling is a sub-optimal means of vibration to chest wall transmission and penetration to the coronary arteries (which are variably situated within the thoracic cavity), and the timed application of vibration limits its effectiveness as there is no vibration during systole. Most importantly the chest wall (which is supported by the bony ribcage) is a relatively rigid structure resistant to soft tissue deformation or displacement relative the deeply situated coronaries within the thoracic cavity, and hence tissue deformations transmitted and impacting the coronaries arteries would be sub-optimal regardless of the force of percussive impacts delivered during therapy.

Diastolic Timed Vibrator (DTV), a low sonic frequency vibration unit adapted to deliver higher amplitude serial percussion to a chest wall surface via a plurality of rib-space locations (to increase chest wall coverage, to increase likelihood of percussion overlying a blocked coronary artery) has been studied by the Applicant as an improvement to the “549” patent's apparatus, and has been the subject of prior patents (e.g. U.S. Ser. No. 10/902,122, incorporated herein by reference) by the device's novel attachment interfaces and use in being combined with thrombolytic drug therapy for treatment of STEMI.

While the DTV benefits a STEMI patient (by relaxing the myocardium, diminishing coronary spasm, improving mixing of intravenously delivered thrombolytic drug delivery into the blocked coronary vessel, and agitating the coronaries to assist reperfusion) again however, even at higher stroke amplitudes as the boney, rib supported chest surface inherently resists anatomically inward deformation or displacement towards the deeply situated coronaries, the potential for delivery of arterial compressions and decompressions within the culprit coronary vessel (which cause localized hemodynamic fluctuations, and greatly assist in the actual erosive breakdown and downstream mobilization of a thrombus) remains sub-optimal.

There has also been little focus in the area of directing or confirming the penetration levels of high infrasonic to sonic frequency vibration or percussion massage techniques to an invasively located vascular target in a patient, via an imaging or monitoring technique.

Japanese Pat. No. JP 4156823 to Takishima et al. disclose a miniaturized accelerometer disposed on a transesophageal lead for monitoring penetration levels of chest wall imparted cardiac phased modulated vibration reaching the heart to facilitate the diagnosis and treatment of heart failure. The requirement of an invasive step of introducing a transesophageal probe to enable confirmation of adequate vibration penetration to vascular tissue targets is not ideal (nor preferred) in emergency settings.

U.S. Pat. No. 5,919,139 to Lin discloses a low amplitude (designed for “gentle percussive hitting or vibrating”) sonic vibration source mounted side by side to an ultrasonic imaging transducer for diagnostic purposes, which enables visualization of the invasive structure vibrated. This device is not used for therapy, and is inexpedient (prospectively) in the location and disruption of tissue targets as the sonic vibration source is not advantageously placed in the same position as the ultrasonic imaging probe upon the body surface, such as to conveniently enable an operator to directly visualize and target the vibration through an optimized sonic penetration window overlying the vascular target.

As can be seen from above, there is an ongoing need to refine and optimize a noninvasive system to assist clearance of acute arterial thrombosis in treatment of STEMI or AIS by drug therapy and/or transcutaneously delivered mechanically therapeutic techniques.

There is accordingly a requirement for a quick, portable, simple to use, noninvasive mechanical method and apparatus that reliably ensures optimized penetration and agitative response to the culprit vessels and sites of arterial thromboses (in particular to the deeply situated coronary arteries within the thoracic cavity, or to the acoustically shielded cerebral arteries within the cranium) to best ensure an adequate clot disruptive therapeutic effect in emergency cases. The system should be optionally portable to enable reaching a victim in the field, employable with drugs such as thrombolytics, and preferably adaptable to suit the expertise of an operator whose skill level and experience (and thereby preferred clinical approach) may vary markedly. Preferably there should also be an easy to use bio-feedback monitoring system to ensure that a significant vibro-agitative response is effectively being implemented to a culprit circulation during therapy.

### SUMMARY OF THE INVENTION

To assist emergency treatment of STEMI or AIS the applicant presents Superficial Arterial Deformation Assisted Reperfusion (SADAR), a non-invasive system that can be initiated immediately after the onset of symptoms in the field by a minimally trained individual.

The SADAR system comprises a method and apparatus for assisting clearance of an acutely thrombosed artery which underlies or is substantially surrounded (or contained) within external, overlying body surfaces which are supported by bone (or contained within a substantially bone supported body cavity such as the thoracic cavity or cranial cavity), whereby the external body surfaces are therefore relatively resistant to deformative compressive displacement relative towards the thrombosed artery by the application of external mechanical force (e.g. impacts, vibration, percussion, oscillations etc.).

The method consists of applying non-invasive, localized, high infrasonic to low sonic frequency percussive massage at a serial impact frequency much greater than a patient's pulse rate directed towards a major, remote, accessible “target blood vessel” preferably contained within a soft body part extending from the torso of the patient (i.e. limbs or neck) and which preferably superficially underlies at least one external body surface consisting of boneless soft tissue which is relatively susceptible to force driven deformation or compressive displacement relative to the target blood vessel. The localized percussions (with external compressions and decompressions thereby applied towards the external body surface) induce marked vessel deformations with resultant blood pressure and flow fluctuations (collectively hemodynamic fluctuations) within the relatively superficial target blood vessel which propagate to the otherwise “acoustically shielded” and deeply situated acutely thrombosed artery to induce the needed agitation and turbulence proximate the thrombosis site to facilitate reperfusion.

The SADAR system is based on the intuition that localized (or focused), transcutaneously imparted vibrations (or oscillations, serial percussions, repetitive impacts, compressions/decompressions, or actuations by other name) delivered by a vibration massage device with a serial impact frequency greater than the pulse rate of a patient receiving treatment, preferably in the high infrasonic to low sonic range (i.e. 8 Hz-1000 Hz, more preferably at least 16-20 Hz to 120 Hz, and most preferably in a range encompassing 50 Hz), at a high palpable force or stroke displacement amplitude (i.e. 0.1 mm-100 mm, the amount highly dependent on the application site, and tolerance/safety level of the patient), whereby the vibrator is preferably directed or pointed towards a relatively superficial target artery (or more broadly target blood vessel) which is preferably palpably underlying the skin surface, which can, given sufficient engagement force of the vibrator pressing against the patient's body/skin surface and stroke amplitude applied by the vibrator, safely and without undue pain cause marked vessel deformations (e.g. compressions/decompressions) with resultant intravascular pressure changes within the target blood vessel which therapeutically propagate to sites of acoustically shielded and deeply situated acute thrombosis which may be either significantly upstream or downstream (i.e. remotely situated) from the application site.

A first complete disclosure of the SADAR concept was described by the Applicant in US Patent Application 20100222723 (parent to this present continuation-in-part filing), filed Apr. 5, 2010, which is incorporated herein by reference in its entirety. The '723 application illustrates the SADAR method in the following writings (see pg. 16 Column 2, Par. 142), “Vibration therapy may also be employed to treat acute Cerebral Vasculature Accidents, preferably once determined as ischemic or embolic in origin, adjunctive to thrombolytic therapy where brain function is still arguably salvageable. Transcutaneous cranial vibration to the vascular regions of the brain of the patient 20 are readily achieved by the methods below. The underperfused body region in this case is the organ and tissues of the brain of the patient 20. The vibrator 10 (with preferably a pair of contacts 12) is advantageously attached to the posterior aspect of the neck of the patient 20, however the lateral or postero-lateral aspects of the neck or even directly over the carotid artery may also be used (thereby providing a more direct acoustic connection to the cerebral arterial vasculature)”. On analysis, this passage describes an acutely thrombosed artery (i.e. a CVA caused by an ischemic or embolic stroke) whereby the method of applying low frequency vibration (defined within the '723 patent application as having a frequency between 1-1000 Hz, preferably 20-120 Hz and optimally encompassing a range including 50 Hz—greater than the patient's pulse rate) upon a remote artery (in this case the “carotid” artery) being distant from the thrombosed cerebral artery is described. It is further noted that the vibration application to reach the carotid is on the neck (an extremity of the torso), whereby the carotid artery is most preferably palpably superficial, with a desirably boneless, external soft tissue body surface covering the carotid artery—hence making the carotid artery easily deformable by non-invasive force driven deformation or vibration stimulus. It is further noted the vascular regions of the brain are within the cranium, which comprises boney external body surfaces resistant to force driven deformation towards the cerebral arteries.

It is accordingly a first aspect of the present invention to provide an emergency system (i.e. method and apparatus) in keeping with the SADAR method enabling an easy to impart, non or minimally skilled therapy for treatment of STEMI or AIS. The method comprising the steps of non-invasively, directing or pointing (or placing) a non-invasive vibrator towards (or locally proximate) a major “target artery” (or more broadly, in case a vein is selected, a major “target blood vessel”) the target artery preferably located superficially (and in most cases palpably) within a limb or neck of a patient (depending on the condition being treated) and most preferably being proximate at least one external body surface comprising boneless (or substantially non-bone supported) soft tissue relatively susceptible to mechanical force driven deformative displacement relative to the target artery, the target artery being remote from an acutely thrombosed artery requiring treatment but preferably (baring safety and accessibility concerns) otherwise as proximate as possible to the acutely thrombosed artery, and applying targeted, localized serial percussion (or oscillations, impacts, compressions/decompressions, actuation, or vibration by other name) with a impact frequency greater than the heart rate of a patient receiving therapy and preferably in the high infrasonic to low sonic frequency range via the vibrator with a suitable engagement force and displacement amplitude (within safety limits) towards the target artery to serially compress and decompress the target artery, preferably as an adjunct to systemically administered drug therapy, and most preferably IV thrombolytic drug therapy.

A second aspect of the present invention is to provide a simple and easy to use monitoring feedback sensor or sensors which inform an operator that the performance parameters delivered by the vibrator—including device positioning (e.g. placement and direction of an oscillating patient contact interface of the vibrator) and mechanical force delivered by the vibrator (e.g. engagement force with accompanying stroke displacement amplitude and selected wave-shape) are causing sufficient and optimized arterial vessel deformations and blood pressure fluctuations into the target artery, to propagate into the systemic circulation to sufficiently reach their intended destination (the acutely thrombosed artery).

A third aspect of the present invention is to integrate the foregoing into an effective emergency response kit for treatment of life threatening acute thrombotic arterial obstructions such as in STEMI and AIS. The kit is optionally portable to meet the needs of first line emergency treatment in the field or emergency room, employable with drugs (and most preferably thrombolytic drugs, with or without acoustically active micro-bubbles), complete with instructions, and adaptable to meet the needs of differing operators with varying levels of training and skill.

It is thereby a particular object of the present invention to provide a preferred vibrator and method of its use in treatment of STEMI or AIS, the vibrator enabling percussion (or impacts, actuations, compressions/decompressions, or oscillations) of an external body surface delivered with a serial or consecutive (or repeating) impact frequency greater than the patient's pulse rate, preferably in the high infrasonic to sonic frequency range (e.g. 8 impacts/second to 1000 impacts/second), more preferably in the low sonic frequency range (e.g. 16 or 20 impacts/second to 120 impacts/second) and most preferably in a range encompassing 50 impacts/second, and with a stroke or displacement amplitude of at least 0.1 mm and up to 100 mm, more preferably in the 1 mm-15 mm range for treatment of STEMI, and 0.1 mm-6 mm range for treatment of AIS.

It is a further object of the present invention to provide a preferred vibrator of the aforementioned type for treatment of STEMI, the vibrator preferably comprising a rapidly inflating/deflating sleeve bladder system, or equivalently a vibrator being attached to and disposed upon a sleeve, the sleeve being attachable around a limb of a patient, and most preferably an arm or arms of a patient (being closer than the legs to the coronary circulation) such as to enable rapid compressions/decompressions of a brachial artery or brachial arteries (if both arms are used) as well as and along with other arteries within the arm of a patient to be treated. The vibrator for STEMI is preferably configured to enable easy, hands free use by a paramedic or medical personnel applying the therapy.

It is a further object of the present invention to provide a vibrator for treatment of AIS, the vibrator being optionally applicable by the hand of an operator (to assist in controllability and fidelity of placement of the device), towards the carotid artey of a patient experiencing an AIS.

It is a further object of the present invention to provide a preferred vibrator of the aforementioned types each containing a stroke or force amplitude regulating mechanism, such as to enable a manual or automated adjustment of prescribed stroke displacement amplitude (or compression/decompression force or pressure) of reciprocating impacts or compressions emitted by the vibrator, which may be very low or very high, or periodically increased or decreased, depending on the size and constitution of the patient, as well as according to the type of affliction treated.

It is a further object of the present invention to provide a preferred vibrator of the aforementioned types each operable to a broad range of selectable serial impact frequency (including swept or ramped frequency within a determined frequency range) and a selection of wave form parameters including randomized vibration (whereby at least one of the frequency or vibratory waveform is randomized), such as to enable an effective research as well as clinical tool.

It is a further object of the present invention to provide a preferred vibrator of the aforementioned types each with a selection of body surface attachment interfaces, such as to accommodate a preferred method and/or variable skill level of an operator in order to enhance percussion transmission, effectiveness, and potential expedience for delivery.

It is a further object of the present invention to provide a vibrator of the of the aforementioned types which enables concomitant ultrasonographic imaging (or ultrasonic inspection) with an ultrasonic imaging transducer disposed at the active end of a percussive contact surface of the vibrator (with 2D and optionally 3D imaging or interrogation, as well as M-Mode and pulse wave Doppler), such that a minimally trained operator may optimize speed and maintenance of accurate placement and direction (or pointing) of the vibrator by directly visualizing and/or assessing blood flow of the targeted artery through an accessible sonic penetration window, as well as assessing the artery for resultant vibration induced vessel deformations (and their degree) to confirm and optimize therapy.

It is a further object of the present invention (particularly useful in STEMI treatment) to provide means for enabling a vibrator of the aforementioned types, to periodically cease or halt emissions of percussion during the systolic period of the cardiac cycle of a patient being treated, in the case the hemodynamics of the patient deteriorate subsequent to the application of “continuously” imparted percussion to a major target artery (i.e. percussion emitted throughout the systole and diastole of a patient, irrespective or indifferent to the cardiac cycle).

It is a further object of the present invention (particularly useful in AIS treatment) to provide a preferred, portable, hands free clamping mechanism in application of percussion to at least one, and preferably both carotid arteries by a pair of vibrators or percussors, whereby the clamp is preferably mountable from a chair or stretcher and operable with robotic arms which enable automatic locating of the carotid arteries (by a force meter, or accelerometer which “palpates” the artery) along with an automated ultrasonic imaging system (with 2D, 3D, 4D, m-mode and Doppler enablements) with a processor to enable computer activated maintenance of percussor positioning and engagement force over the target arteries to cause an appropriate level of arterial vessel deformations while ensuring a safe level of blood flow is maintained through the carotid arteries of the patient.

It is a further object of the present invention, (particularly useful in AIS treatment), to integrate use of a vibrator of the aforementioned types with an automated ultrasonic stroke diagnostic helmet (or head fixture) which provides real time 3D or 4D transcranial ultrasonic images to assess when an acute ischemic (i.e. embolic) stroke has occurred, and to also provide images as to when reperfusion of an acutely thrombosed cerebral artery has taken place, to enable instigation and completion of percussive therapy in the field respectively, or during pre-hospital thrombolysis.

It is a further object of the present invention to provide an easy to use, non or minimally skill based monitoring bio-feedback sensor to assess arterial vessel deformations and/or fluctuating blood pressure (or blood flow or blood volume changes) received by a measurable artery, the measurable artery being preferably co-equally distant or further remote from the target artery (that being directly deformed) than the distance between the target artery and the acutely thrombosed artery in need of treatment, to ensure adequate and optimized; positioning, direction, engagement force, stroke displacement amplitude (or compression/decompression force or pressure), and optionally wave-shape or wave pattern emissions are applied and being emitted by the vibrator upon a chosen application site.

It is a final overall objective of the invention to provide a SADAR treatment system or kit for STEMI and/or AIS, comprising at least one vibrator or percussion unit of the aforementioned types, along with a suitable monitoring bio-feedback sensor to ensure optimized vibrator positioning and vibration delivery. The kit will also preferably include hemodynamic monitoring equipment (including non-invasive blood pressure and ECG monitoring), IV supplies and a supply of suitable emergency drugs including at least one thrombolytic agent and ultrasonically active micro-bubbles intravenously inject able to the patient, as well as detailed instructions to assist an operator in use of the kit (including variations thereof), to enable pre-hospital or emergency in-hospital IV thrombolysis adjunctive to the SADAR technique.

### BRIEF DESCRIPTION OF THE DRAWINGS

The apparatus and method of the present invention will now be described with reference to the accompanying drawing figures, in which:

FIG. 1 is a perspective view of a supine patient receiving therapy from an operator held vibrator placed to the abdomen overlying the abdominal aorta of a patient in a first generation treatment of STEMI according to the invention.

FIG. 2 is a perspective view of a prone patient receiving therapy from an operator held vibrator placed to the lower back with a resilient tubular prop placed below the abdomen of a patient in an alternative first generation treatment of STEMI according to the invention.

FIG. 3. is a perspective view of a semi-reclined patient receiving therapy from a pair of high frequency bladders encircling the patient's upper arms (to overly the brachial arteries), whereby the bladders are adapted to rapidly inflate and deflate with a serial impact or compression/decompression frequency in the high infrasonic to sonic frequency ranges, in a preferred, second generation hands free treatment of STEMI and optional treatment for AIS according to the invention.

FIG. 4 is a perspective view of a supine patient receiving therapy from an operator held vibrator placed to the left common carotid artery in an optional, first generation simple method for treatment of AIS according to the invention.

FIG. 5 is a perspective view of a supine patient receiving treatment from an operator held vibrator incorporating a percussive ultrasonic imaging contact interface enabling 2D, m-mode and Doppler monitoring (to expedite correct placement, optimized engagement force, and maintained targeting of percussion over a carotid artery) via an optional minimally skilled second generation procedure in treatment of AIS according to the invention.

FIG. 6 is a perspective view of a semi reclined patient receiving therapy from a bilaterally clamped pair of vibrators placed to the carotid arteries in a preferred, hands free, third generation automated treatment of AIS according to the invention.

FIG. 7 is a graphic illustration of a variety of potential vibratory displacement wave forms including (top to bottom); sinusoidal, percussive impact (square wave with steep displacement rise), linear, accelerating (saw-tooth), wept vibration (with varying frequency), and randomic vibration (with varying frequency and waveform).

FIG. 8 is a diagrammatic illustration of a battery of blood pressure pulses propagating towards and striking a clot within an acutely thrombosed artery as a result of remotely induced, serial applied arterial vessel deformations of a larger target artery, with a serial impact frequency far exceeding the pulse rate of a patient being treated according to the invention.

### DETAILED DESCRIPTION

ST Elevation Myocardial Infarction (STEMI), the most serious form of heart attack, is a consequence of a complete or prolonged obstruction of a major epicardial coronary artery. Studies show that myocardial muscle necrosis occurs approximately between 15 to 30 minutes after the onset of symptoms. Therefore, the speed of intervention is the prime factor affecting the amount of myocardial muscle death and thus the patient survival rates. Time is even more so of the essence in treatment of Acute Ischemic Stroke (AIS), as brain cells are particularly susceptible to acute ischemia. Adjunctive treatment methods that could be initiated in the field or prior to patient arrival to the emergency room, cath-lab or invasive neurological special procedures unit aiming at inducing clot dissolution or even its displacement further down the bloodstream (to less harmful territory) could potentially offer beneficial effects to patients.

The SADAR system is particularly effective when a deeply situated, acutely thrombosed artery underlies a preponderance of bone supported, relatively rigid (more difficult to deform or displace by mechanical force) external body surfaces such as those of the thoracic cavity (which is supported by the sternum, spine and ribs which overly, and substantially surround and contain the coronary arteries) or cranium (which is supported by the frontal bone, parietal bone, occipital bone and temporal bones which overly and substantially surround and contain the cerebral arteries), hence making direct targeting of these vessels to produce serial vessel deformations by non-invasive, localized high infrasonic to low sonic percussive or vibratory compressive massage sub-optimal (and in the case of AIS virtually impossible).

The SADAR method consists in applying non-invasive mechanical actuation at a repeating impact frequency advantageously greater than the patient's heart rate, preferably in the high infrasonic to low sonic frequency range (i.e. 8 impacts/second to 1000 impacts/second), more preferably low sonic (16-20 impacts/second to 120 impacts/second) and most preferably a range of frequencies encompassing (50 impacts/second), to induce serial deformations (e.g. compressions/decompressions), of a major “target” artery which is substantially remote (but baring safety concerns otherwise as close as possible) from an acutely thrombosed artery and which is preferably superficially proximate at least one substantially boneless (or substantially non-bone supported), soft, deformable, displaceable external body surface upon a body part extending from the torso of the patient, such as preferably the brachial artery(s) in STEMI cases and the carotid artery in AIS cases.

By experimental observations the Applicant has found that vibration with serial impact frequencies greater than the pulse rate, preferably in at least the high infrasonic range (e.g. at least 8 Hz, or 8 impacts/second or 8 vessel compression/decompression cycles per second) are generally required to cause significant turbulence in fluid systems to provide a significant clot erosive effect. More preferably, even higher energy vibration at higher frequencies in the low sonic range (e.g. 16 Hz or 20 Hz minimum), and most preferably (by experimental observation) in the 50 Hz range, are used to confer a higher energy, more optimized clot disruptive effect. As vascular organs are generally known to be supported by tissue with resonance frequencies in about the 20-120 Hz range it is thereby an additional object of the invention to preferably tailor percussive therapy within this range, in anticipation of an optimized vascular response to propagated pressure fluctuations and oscillations at the thrombosis site.

Target blood vessel deformation (which preferably causes a compression of at least 1-2%, and up to 100% of a target blood vessel's (or artery's) non-provoked vessel diameter—a value highly dependent to the application site and type of affliction treated) causes a battery of pressure waves and vessel deformations at a frequency greater than, and preferably much greater than the patient's pulse rate to be propagated along the length of the target artery to adjoin arterial connectors to thereby reach the more acoustically shielded acutely thrombosed artery. A non-uniform force distribution reaches the thrombosis site inducing shear stresses and deforming the clot. This causes clot erosion and development of clot adjacent fluid channels within the arterial lumen to enhance early flow, as well increasing the likelihood of detachment of thrombosis from an arterial lumen site which assists reflow of the major epicardial or cerebral vessel, delivery of clot disruptive medicants (such as thrombolytics and/or ultrasonically active micro bubbles) with increased clot exposure, and moves the clot downstream distally to less harmful territory. Furthermore, a high degree of turbulence and mixing is initiated in the blood stream proximate the acute thrombosis site (particularly at the juncture where the systemic flowing circulation meats the stagnant flow within the blocked artery) helping in drug delivery from the systemic circulation to the clot even in absence of flow.

For STEMI treatment in particular, it is generally desirable to emit a high, or even maximized stroke displacement amplitude of vibration (or serial compressions and decompressions) being highly dependent on the impact frequency selected and the target artery aimed to be repeatedly deformed. For example, in the non-preferred embodiment where an oscillation device is applied over the abdominal aorta or lower back of a patient to deform the abdominal aorta, when serial impact frequencies in the low sonic ranges (such as at 16 Hz or 20 Hz-120 Hz, or more preferably a range encompassing 50 Hz) are selected, stroke amplitudes of preferably at least 1 mm, but more preferably at least 2 mm, and most preferably in the range of 4 mm-15 mm with a high engagement force (of the vibrator pressed against lower torso) is generally required to enable levels of abdominal vessel deformation which may propagate to reach their target. However if slightly lower frequency serial impact emissions in the high infrasonic ranges are selected (e.g. 8 Hz-16 Hz or 20 Hz), which may be more comfortable or tolerable an application to select individuals, then even higher stroke displacement amplitudes of oscillations emitted from the vibrator may be considered, such as 15 mm-100 mm.

For safety and comfort reasons it is not recommended to externally (and rapidly) compress and decompress a patient's abdominal area (i.e. to compress/decompress the abdominal aorta), but if this technique was to be utilized in treatment of a STEMI patient (perhaps it may be suitable for more slender individuals where the abdominal aorta is palpable), the engagement force of the vibrator, regardless of selected frequency or stroke amplitude, would require maximization to—and likely beyond at times—a level of patient's tolerance and safety (e.g. preferably 20 N-50 N, but possibly up to even 100N). Significant engagement force of a vibrator attachment interface against a body surface will cause the underlying soft tissue (between the skin and target artery) to deform, displace and compress over top of the targeted blood vessel (in this case an artery), making any further oscillations emitted from the vibrator beyond this compression most efficiently transmitted in causing serial deformation of the target artery's lumen. This concept is especially important in STEMI cases as the abdominal aorta is a relatively non-superficial deep structure and is far distant from the coronary arteries, so the deformation response of the abdominal aorta, if used, would need to be maximized. However, tests performed by the Applicant in the ultrasound lab have generally found that it is very hard if not impossible to compress the abdominal aorta unless borderline to dangerously high levels of sustained oscillative force (like used in CPR—with up to 100 mm of up and down stroke displacement) are used, and such force would be even more uncomfortable and possibly unsafe if delivered at required higher frequencies much greater than the patient's pulse rate. Hence, this first generation technique would have to used with extreme caution and only in select patients if to be used clinically.

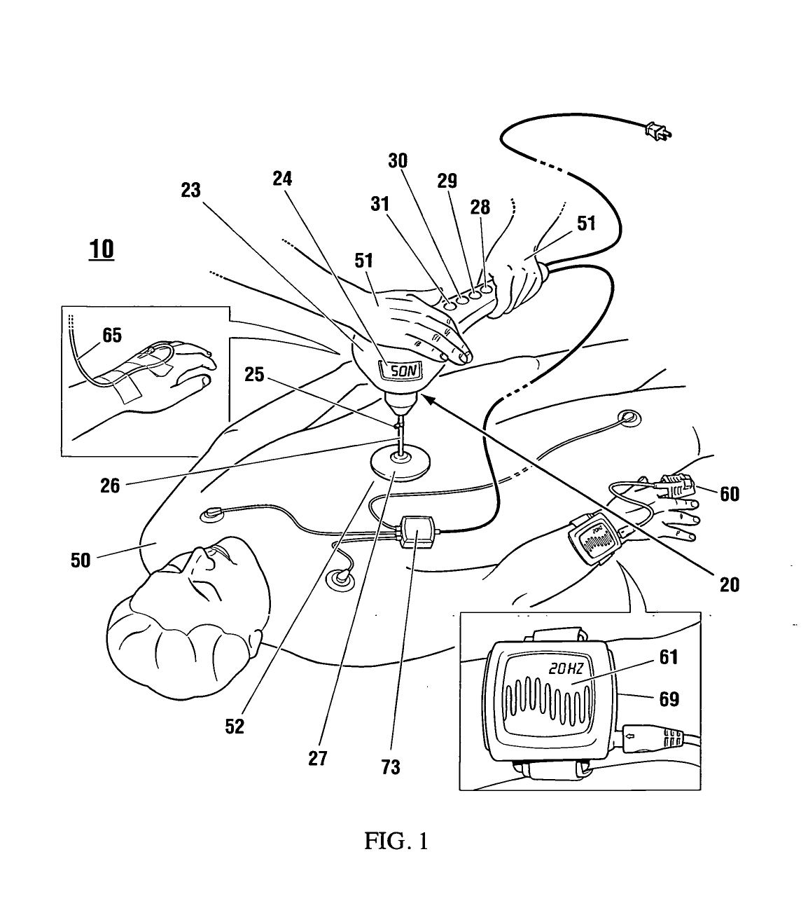

In attention to FIG. 1, a non-preferred, first generation pre-hospital or emergency room based SADAR system 10 for treatment of a supine patient 50 experiencing a STEMI is shown. Vibrator 20 is applied to by the hands 51 of an operator localized upon anterior body surface 52 which is proximate and directly overlies in this case the abdominal aorta (not shown). Hand delivered engagement force of vibrator 20 is monitored by a force meter (not shown, under the right hand 51 of the operator), disposed upon vibrator head 23 of vibrator 20 to provide a digital read out 24 (in this case 50 Newtons is shown). An accelerometer 25 is disposed upon shaft 26 of percussive contact interface 27 which is projected from the housing of vibrator 20 to enable motor driven reciprocating oscillations, towards and away from body surface 52. A stroke displacement regulating control 28, a percussion frequency selection control 29, a percussion wave shape selection control 30 (enabling a selection of emission of sinusoidal waves, accelerating or saw-tooth waves, high energy percussive square waves with a steep displacement amplitude rise and linear waves), and a percussion mode selection control 31 (enabling a selection of swept frequency percussion within a pre-selected frequency range, and randomic or varying percussion with randomly varying wave-shape and frequency within a pre-selected frequency range) are all disposed on the housing of vibrator 20 in easy access to the hands 51 of the operator.

The application of vibrator 20 for applications against the lower torso involves use of a hand held technique which aids quick controllability of vibrator 20, which may require quick disengagement (if patient 50 became nauseous for example), or a modified engagement force (as shown on display 24) of vibrator 20 pressed against body surface 52 based on articulations or complaints from patient 50 (such as if patient 50 indicates the application is too hard, or too painful from moment to moment) or if the engagement force or location of vibrator 20 needs to be moved slightly from time to time, again to instill comfort to the patient 50 or to maintain a good oscillative response of the abdominal aorta (according to data derived by a bio-feedback monitoring system, discussed below). A sedative or pain killer (or even conscious sedation method if available) may be further required to patient 20 to assist with a great deal of discomfort experienced through application of vibrator 20. It is herein emphasized that serial deformation of the abdominal aorta by abdominal wall vibration is not generally advised by the Applicant, but may be an option perhaps in very slender patients with a soft compliant abdominal wall.

A finger optical plethysmograph 60 is advantageously applied upon the finger tip of patient 50, for assessment of serial arterial blood volume changes within the arterial system of the finger (resulting from propagating blood pressure and flow fluctuations—collectively hemodynamic fluctuations—from the locally compressed and decompressed abdominal aorta) conforming to the selected frequency emissions as established by accelerometer 25, to confirm and guide correct positioning and a required selection of engagement force (and optionally wave shape or wave pattern emissions) of vibrator 20 upon body surface 52. The plethysmographic trace is shown upon a display screen 61 on wrist monitor 69 to show a characteristic oscillative waveform (which substantially dominates and is superimposed upon the arterial blood pressure like waveform), at the emission frequency of vibrator 20 when placement and engagement force of vibrator 20 is optimized, with the higher the amplitude of the rapid oscillative deflections the more optimized the placement. Wrist monitor 69 advantageously communicates with vibrator 20 by telemetry.

A biofeedback system, as illustrated by finger optical plethysmograph 60, is highly preferable in execution of the SADAR method to confirm that the vessel deformations induced by vibrator 20 at the target artery (e.g. in this illustrated case the abdominal aorta) create sufficient and preferably maximized blood pressure variations and propagating vessel deformations and flow (or volume) changes in the bloodstream to reach a remotely situated thrombosed vasculature (e.g. an acutely thrombosed coronary artery). Since the distance from the abdominal aorta to the arteries within the arterial vasculature of the finger is greater than the distance from the abdominal aorta to the coronary arteries, pressure variations (with accompanying vessel deformations and blood volume changes) detected at the finger will conservatively correspond to the pressure variations and vessel deformations at the occlusion site in the coronary arteries. This feedback system would not be used to perform measurements of the pressure wave amplitude, but rather to choose an optimal placement of the device to, particular to STEMI applications, maximize the pressure variation amplitude. Therefore, it would be subject independent and no calibration would be necessary.

A particular advantage of the SADAR system in STEMI cases is that since vibrations are not being applied directly upon or towards the heart tissue (i.e. the myocardium), systolic vibration (particularly during the early to mid force generation aspects of systole), which is otherwise known to cause a weakening of heart contractions in ischemic heart conditions, need not necessarily be avoided. Hence the SADAR percussive waveforms can be administered throughout diastole and systole of a cardiac cycle (or at any time during the cardiac cycle, or irrespective of the cardiac cycle) in STEMI cases hence maximizing overall exposure of the acutely thromobsed arteries to mechano-agitative, clot disruptive therapy.

Should however the hemodynamics of a STEMI patient deteriorate during serial percussion administered “continuously” (i.e. percussion applied without pause according to its selected frequency, indifferent to the cardiac cycle and therefore also during and substantially throughout systole), which may be a concern as repeated, rapid systolic compressions of a major artery will tend to increase left ventricular after-load (or peripheral arterial resistance to flow) which may jeopardize a weakened heart's ability to generate sufficient cardiac output, emissions of vibrator 20 can be periodically halted or ceased during the systolic period of the patient's cardiac cycle by application of ECG monitoring and triggering of an active braking mechanism within the device at first recognition of a Q wave, or more preferably upon first recognition of a P wave-Q wave complex (or P-Q complex) of a patient according to the invention.

The problem with predicting onset of mechanical systole through ECG identification is that the first singular robust sign of imminent mechanical systole on the ECG is the first significant steep rise (dv/dt) of an R wave which only gives at best 20 ms prior warning in stopping vibrations before the R wave peak, which generally matches in many cases the onset of early mechanical systole. Using a P wave alone to foreshadow the onset of left ventricular systole is problematic, as P waves are of low amplitude and will be extra difficult to interpret with vibration being applied to a patient's skin surface which contaminates the tracing. This is generally true also of determining a Q wave alone, which is also of low amplitude. However, when a regularly occurring P-Q complex with a definable P-Q delay is determined on the ECG trace, the recognition of a subsequent P-Q complex is (unlike P waves or Q waves alone) particularly robust, and hence determination of a suspected Q wave following a suspected P wave which matches prior determined template criteria can be trusted. Hence immediately following recognition of a “P-Q complex” (i.e. at the Q wave), an active breaking of the percussive emissions is preferably accomplished by reversing electrical polarity which drives an electromechanical reciprocating motor (preferably a linear stepper motor) disposed inside the housing of vibrator 20, to halt vibration emissions. Alternatively a piezoelectric braking system which adds resistance to the moving components of the reciprocating motor can be added or used independently to maximize the motor's breaking action.

Monitoring for the presence of a regularly occurring P-Q complex is particularly desirable when a patient is in sinus rhythm (especially when there is a fairly constant P-Q interval on the ECG waveform), as this again provides earliest warning of impending mechanical systole right at the Q wave (emphasis), which provides extra lead time prior to the onset of mechanical systole, thereby offering the most time possible to enable stoppage of vibrator 20. In the absence of a regular P-Q interval (such as in atrial fibrillation or junctional or ventricular rhythms) the device will default to sensing the earliest recognizable aspect of the R wave, to thereby send an command to terminate vibration emissions. The onset of percussion is re-established upon a heart rate dependent pre-programmed timing delay which aims to occur at or near end systole (usually near the peak of the T wave), or at the beginning of diastole. The application of diastolic timed vibration obviates the heightened after-load concern of compressing a major artery during systole.

To this end (and in further reference to FIG. 1) wrist monitor 69 is advantageously configured to double as a non-invasive blood pressure monitor of patient 50 to periodically monitor radial blood pressure, and ECG module 73 stemming from vibrator 20 enables ECG input for determining heart rhythm, including identification of the early onset of the R wave, and most preferably (when available) the P-Q complex. The foregoing enables automated periodic cessation of percussion emissions during at least the early to mid aspects of systole, in case hemodynamic compromise (e.g. blood pressure dropping below 90 mm Hg, or with a sudden drop of 20 mmHg from baseline) occurs following onset of oscillations applied continuously, or indifferent to the cardiac cycle. Outputs from all sensing apparatus and control features as illustrated above are inputted to a central processing unit contained within vibrator 20 (not shown) to enable proper co-ordination of therapy. An IV line 65 is additionally shown to enabling injection of thrombolytic drugs plus or minus IV microbubbles to best enable the system for pre-hospital thrombolysis, which is the preferred treatment scenario in treatment of STEMI.

A preferred SADAR therapy session in treatment of STEMI will involve uninterrupted rapid serial percussion for a period of about 20 minutes, or continued until measurable signs of reperfusion such as a relief of patient symptoms accompanied by a reduction of ST segment elevation of at least 50% based on serial '12 lead ECG readings which is known to indicate TIMI 3 (or complete) restoration of epicardial coronary flow.

It requires mention that while vibration applied upon the anterior body surface 52 overlying the abdomen is for reasons explained above not the preferred choice in STEMI or AIS cases (and it is recognized that the majority of individuals have abdomens which cannot receive high levels of vibration comfortably or for sustained periods, safely), some individuals have particularly relatively rigid, fleshy abdominal regions or severe chronic gastrointestinal problems which cannot bear even low intensity percussion, therefore an alternate means for employing serial vessel deformations of the abdominal aorta, while still not preferred—is again for sake of illustration herein presented. To this end one may alternatively place vibrator 20 upon the lower back of a prone patient (on, but more preferably to either side of the spine via a preferred dual, or multi contact node configuration), whereby the spine and tissue about the spine (as the lower spine is substantially free floating, not propped up in position by the ribs) is highly compressible or moveable (towards the abdominal aorta) and can transmit vibration efficiently towards the abdominal aorta. Low back vibration is a particularly advantageous alternative to direct abdominal vibration, as an extremely high stroke amplitude of vibration at high engagement force is commonly well tolerated (and in fact perceived as an enjoyable back massage) by most individuals.

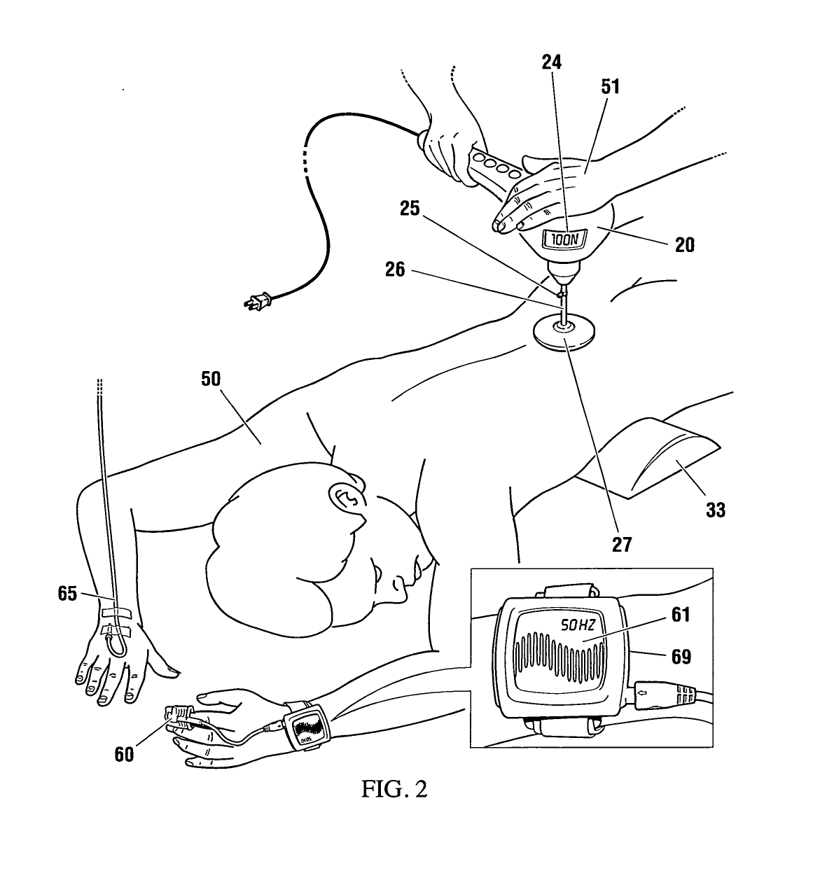

In attention to FIG. 2 a more acceptable variation of positioning of patient 50 in the prone position for treatment of STEMI is thereby shown. Contact interface 27 of vibrator 20 is in this case placed upon the lower back of patient 50 with percussion contact interface 27 placed overlying the spine of patient 50, whereby a resilient, substantially incompressible curved prop 33 is advantageously placed below the abdomen of patient 50 such that percussive forces from vibrator 20 are most efficiently transmitted to cause serial compressions of the abdominal aorta by a combination of active lower back compressions with prop counter compressions. In essence, prop 33 keeps the abdomen from moving away from, or dampening the compressive forces applied by vibrator 20 upon the lower back of patient 50 (just as resilient CPR boards are used to facilitate CPR administration to a patient's chest wall), so rapid serial compressions to the lower back are best transmitted to the abdominal aorta. An IV line 65 is again shown to enable administration of thrombolytic and other helpful medications. Wrist monitor 69 housing display screen 61 which shows the plethysmography trace from optical finger plethysmograph 60 is again shown, this time indicating an oscillative frequency of 50 Hz which matches the oscillation measurements derived by accelerometer 25 on vibrator shaft 26. Force meter display 24 in this case shows a value of 100 Netwons, which is a realistic engagement force when vibrator 20 is applied to the lower back, as vibration massage to the lower back is extremely well tolerated (and in fact often felt as enjoyable) to the majority of patients.

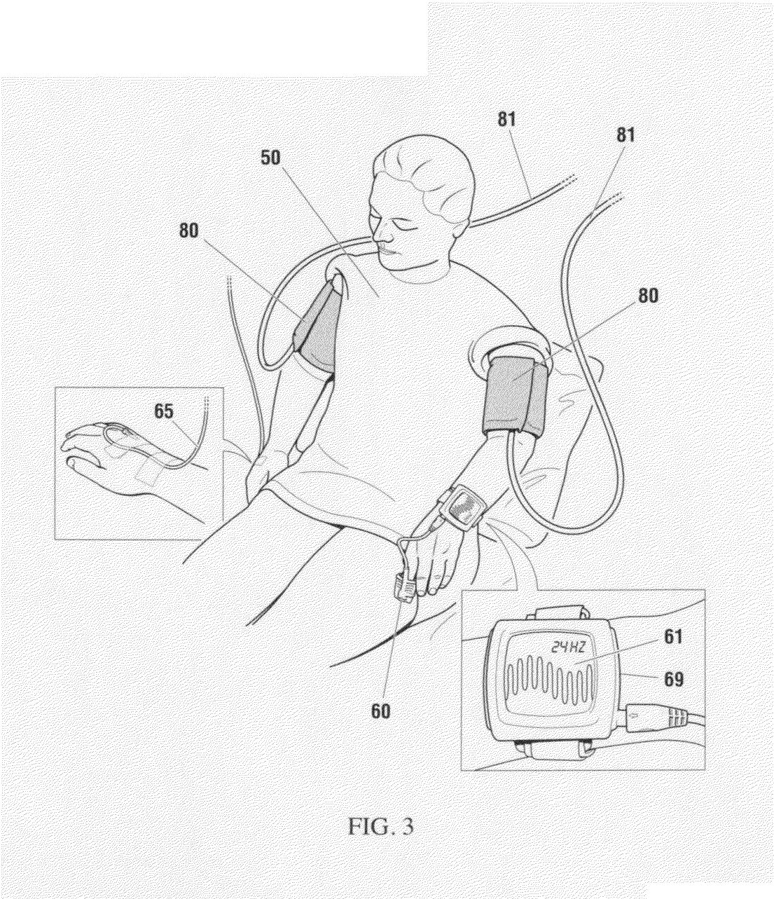

In attention to FIG. 3, a preferred, safe alternative hands free means for treatment of STEMI (or optional treatment for AIS) is shown to semi-reclined patient 50, via the use of a pair of “high frequency” bladders 80, each bladder 80 disposed within a sleeve (or cuff) encircling an upper arm. In this embodiment, bladders 80 advantageously locally vibrate towards and away from the body surface of the upper arm overlying the superficial (located relatively near the skin surface) brachial artery, which is accomplished by use of an extremely fast acting pneumatic pressure pump (not shown) attached to bladders 80 by pneumatic pressure lines 81. Bladders 80 alternate between rapid inflations up to preferably 200 mm Hg pressure (or higher, up to a maximum of 350 mm Hg if the patient is obese or hypertensive) for compressions, and rapid deflations to between about 50 to 80 mm Hg for decompressions, at repeating cycle rates greater than the patients pulse rate (and according to a preferred emission frequency in the high infrasonic to sonic frequency ranges as previously specified according to the SADAR method). Stroke amplitudes of oscillating bladder(s) 80 (administrable towards and away from the skin of the selected limb of a patient) advantageously lie within the 0.1 mm-100 mm range, and preferably (in both heart attack or acute ischemic stroke cases) in the 1 mm-15 mm range to ensure adequate, rapid compression/decompression of the brachial artery (or other artery if applied to example the legs of patient 50). The output of finger optical plethysmograph 60 is shown in this case with a display screen 61 disposed upon wrist monitor 69 (in this case showing a serial compression/decompression or impact frequency of 24 Hz), whereby wrist monitor 69 also advantageously doubles as a non-invasive blood pressure monitor. To obtain blood pressure readings by wrist monitor 69 cessation of serially applied compression/decompressions are transiently indicated by at least one bladder 80. High frequency bladders 80 may optionally be configured to periodically halt compressions/decompressions at some point during the systole of the cardiac cycle (in STEMI cases) by use of an ECG triggering system as described above (not shown in FIG. 3). IV line 65 is shown to enable delivery of intravenously thrombolytic drugs to fully optimize the SADAR reperfusion technique.

A preferred application of oscillating bladders 80 in treatment of STEMI or AIS is deployed about the upper arms (as the brachial arteries are relatively proximate to the coronary or cerebral arterial vasculature as compared to the leg arteries or the abdominal aorta), and alternatively only one arm may be used rather than two to eliminate any risks of destructive interference of the propagating pulses from the right and left brachial artery, which may be (or may not be) in phase when they meet within the aortic arch. This technique is particularly advantageous, as while the target artery is smaller (than the preferred abdominal aorta), there is no worry about adequate vibrator positioning or engagement/compression force (the brachial artery will, independent of device positioning, in all cases be maximally deformed), the technique is reasonably comfortable to the patient, and in this case a feedback mechanism (such as finger optical plethysmograph 60—or other bio-feedback variations to assess the degree of propagating vessel deformations or blood pressure/flow or volume fluctuations—discussed later in this disclosure) may be used to further tailor the vibration emission therapy to enable an optimization of other particular vibrator performance parameters (such as an adjustment of maximal inflation pressure or stroke amplitude or waveform or wave pattern type) to provide the highest amplitude of propagating pressure pulses possible which is particularly desirable in STEMI applications.

As a non-preferred alternative the legs of the patient may be oscillated by a similar—but preferably larger—bladder system as a stand alone procedure or in co-ordination with upper arm oscillations, however this technique is non-preferred as the femoral arteries are disadvantageously far remote from the coronaries or cerebral arteries and leg cuffs are awkward and difficult to apply in ambulatory, emergency situations.

It is worth noting that the carotid artery, while more proximate to the coronaries than the abdominal aorta or brachial arteries, is also not generally recommended for use as the “target artery” to be percussed in STEMI treatment, as SADAR percussion will be preferably associated with a co-administration of systemically delivered fibrinolytic or other powerful clot disruptive drugs which may carry an increased risk for cerebral arterial hemorrhage (hence aggressive shaking or vibration of the neck or head region is not generally recommended). However, if a STEMI treatment by the SADAR method (with brachial arterial serial deformations) is not causing timely reperfusion (e.g. as judged by a lack of ST elevation resolution on the ECG) and the patient's life is otherwise deemed significantly in jeopardy (e.g. recurrent ventricular arrhythmias are being expressed, possibly with heart failure or hemodynamic evidence of cardiogenic shock etc.), then carotid arterial percussion along with, or as an alternative to brachial arterial deformation be considered at the discretion of a physician according to a risk benefit analysis to increase impact of the reperfusing effects of the SADAR method. Alternate target arteries for direct compression/decompression in treatment of STEMI may also be selected, including at least one (but preferably both) brachial arteries—the technique being discussed more thoroughly below.

With regards to AIS treatment, the preferred target artery to be vibrated is at least one artery residing within the neck of an individual, most preferably the common carotid artery, which is advantageously in relatively close proximity to an acute cerebral thrombotic occlusion, a fairly large artery, is very close to a non-bone supported skin surface, and is very easy to locate by an operator of the SADAR method (such as by manual palpation).

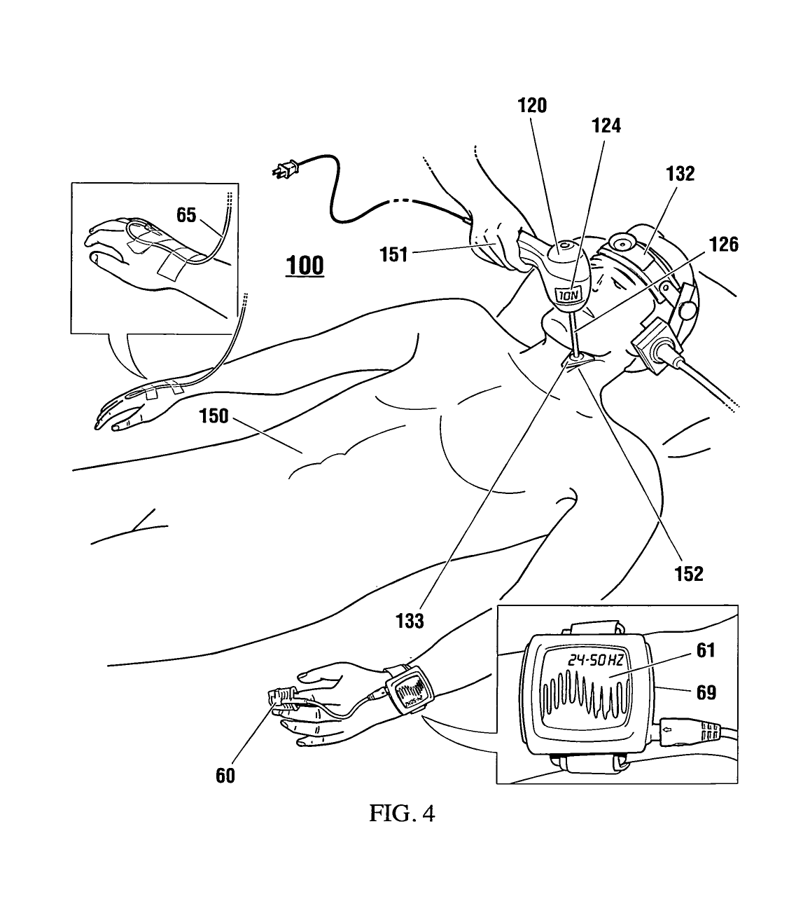

In attention to FIG. 4 a “simple” first generation pre-hospital or emergency room based SADAR system 100 for treatment of AIS is shown. Vibrator 120 is applied to supine patient 150 by hand 151 of an operator upon in this case external body surface 152 locally overlying the carotid artery. Vibrator 120 is very similar to vibrator 20 (as illustrated for STEMI) accept is lighter with a smaller motor (again preferably a linear stepper motor contained within the unit—not shown) and has a unique, tailored triangular percussive contact interface 133 sized and shape to enable optimal, wedged in seating within the carotid triangle (between the posterior belly of digastric muscle, superior belly of the omohyoid muscle proximate the trachea, and anterior border of sternomastoid muscle) of patient 150. Percussive contact interface 133 has a widest dimension—at the base of the triangle—of 20 mm (more than twice the diameter of a typical carotid artery) to ensure adequate and complete coverage over the carotid artery, although smaller dimensions (e.g. of at least 7 mm, the typical size of a carotid artery, may alternatively be employed). Hand delivered engagement force of vibrator 120 against body surface 152 is monitored by a force meter disposed in this case within the casing of vibrator 120 (not shown) to provide a digital read out 124 (in this case showing 10 Newtons) to enable monitoring and delivery of prescribed engagement force of the device against external body surface 152. An accelerometer (also not shown) is disposed within the shaft 126 of percussive contact interface 133 which is projected from the housing of vibrator 120 to enable motor driven reciprocating percussion (and monitoring of percussion) of percussive contact interface 133, towards and away from body surface 152.

As in the STEMI application a stroke displacement regulating control, a percussion frequency selection control, a percussion wave shape selection control (enabling a selection of emission of sinusoidal waves, accelerating or saw-tooth waves, and high energy percussive square waves with a steep displacement amplitude rise), and a percussion mode selection control (enabling a selection of swept frequency percussion within a pre-selected frequency range, and randomic percussion (with randomly varying wave-shape and frequency within a pre-selected frequency range) are all disposed (but not shown) on the housing of vibrator 120 in easy access to operator 151.

Finger optical plethysmograph 60 is again in this case also applied to the finger tip of patient 150, for assessment of blood volume changes to the arterial system within the finger conforming to the selected frequency emissions of the application (as determined by the accelerometer disposed within shaft 126), to confirm and guide correct positioning and adequate engagement force of vibrator 120 upon body surface 152 in effectively deforming (or equivalently compressing) the carotid artery. The plethysmographic trace is again shown on display screen 61 on wrist monitor 69 (the same system as previously described for STEMI cases) to show a characteristic oscillative waveform which substantially dominates the arterial blood pressure like waveform, (in this case shown as a randomized frequency and randomly administered waveform have a frequency range encompassing 50 Hz) when placement and engagement force of vibrator 120 is optimized, with the higher the amplitude of the deflections the more optimized the placement. Alternatively, employable vibration frequencies may be utilized in the high infrasonic to sonic frequency ranges, as previously specified according to the SADAR method.

An ultrasonic diagnostic helmet 132 (such as preferably the Duke Brain Helmet or head fixture), which enables real time automatic 3D ultrasonic scanning and detection of cerebral blood flow conditions, is preferably applied to the head of patient 150 to enable diagnosis of an acute ischemic (or embolic) stroke—which thereby authorizes the initiation of SADAR percussive therapy, in the ER or even in the field in pre-hospital situations. Ultrasonic diagnostic helmet 132 also acquires images during SADAR therapy which determine when successful cerebral reperfusion has taken place. Images from ultrasonic diagnostic helmet 132 are preferably sent to a radiologist in hospital by telemetry before and during treatment. Upon assessment of successful reperfusion, the radiologist will inform the paramedic to begin decreased emissions of percussive stroke displacement amplitude (such as to assist in maintenance of the recanalization) or cessation of percussive therapy. IV line 65 enabling injection of thrombolytic drugs and/or acoustically active IV microbubbles is also preferably provided to best enable the SADAR method for treatment of AIS. Sympathomimetic agents (such as isoprel or adrenaline etc.) should be kept on hand during the application, as stimulation of the carotid artery by mechanical massage may lead to a vagal response in select individuals.

One difference in AIS versus STEMI applications by the SADAR method is that for AIS the localized vibratory deforming or compression response of the target carotid artery (as it is very proximate the acutely thrombosed circulation) is not intended—for safety reasons, to be necessarily maximized. In AIS treatment a relatively gentle percussion stroke displacement amplitude of 0.1 mm-6 mm is recommended (preferably about 1 mm-2 mm), with a correspondingly gentle engagement force of the vibrator being pressed against the carotid (e.g. 5 to 10 N, preferably no greater than 20 N)—just enough to gently compress the carotid artery (i.e. during in-activation of the vibrator) which thereafter further compresses and decompresses the artery when percussion is actively administered.

The carotid artery is very superficial, being highly proximate the skin surface of the neck (i.e. often within 0.5-1 cm) so is very easily reachable by externally delivered mechanical percussion and susceptible therefore to externally driven vessel deformations. As specified earlier it is generally preferred to cause target arterial deformations of, where possible, at least 1-2% and up to about 100% of the artery's non-provoked diameter to provide helpful propagating reperfusion effects while, during retraction or decompression phases, maintaining flow through the artery. So, assuming a typical carotid arterial diameter of 7 mm, a minimum of 0.1 mm and up to about 7 mm stoke displacement amplitude oscillation emitted from the percussion device is therefore generally indicated according to the invention. In the case of AIS however, to prevent intra-cerebral bleeding (and limit risks of hemorrhagic transformation- or reperfusion injury) at the price for superior reperfusion, a more conservative 1 mm to 2 mm stroke displacement amplitude percussion (leading to about a 10%-30% vibration induced deformation of the carotid artery), and to avoid complete arterial collapse no more than about a 6 mm stroke amplitude displacement is advised, although of course lower displacement amplitudes (as low as 0.1 mm) may be selected in some more fragile, older patients according to the discretion of the physician. It is also recommended to gradually increase the stroke displacement amplitude in AIS applications (e.g. 0.1 mm for one minute, 0.2 mm for next minute, 0.3 mm for next minute, 0.4 mm for next minute and so forth up to 2 mm (or any similar slow time-wise progression within the 0.1 mm-6 mm range), whereby reperfusion of the culprit artery is monitored in real time by telemetry information sent by ultrasonic diagnostic helmet 132 such that when reperfusion is re-established lower stroke amplitudes or cessation of percussive treatment is at that point indicated.

While positioning of a vibrator 120 to compress the carotid artery is easily achieved by palpation of the artery and use of a reasonably broad surface area percussive contact surface (supplied by triangular percussive contact surface 133—as seen in FIG. 4), the carotid artery can nevertheless sometimes “roll” or shift slightly away from the percussive contact point so a more exacting means of targeting and maintenance of positioning a percussive massager upon the carotid may be desired as an alternate means in administration of the SADAR method. Locating and visualization of the common carotid artery by diagnostic ultrasound is, unlike cardiac sonography or TCD, a relatively easy procedure within the grasp of a paramedic or nurse with minimal training,

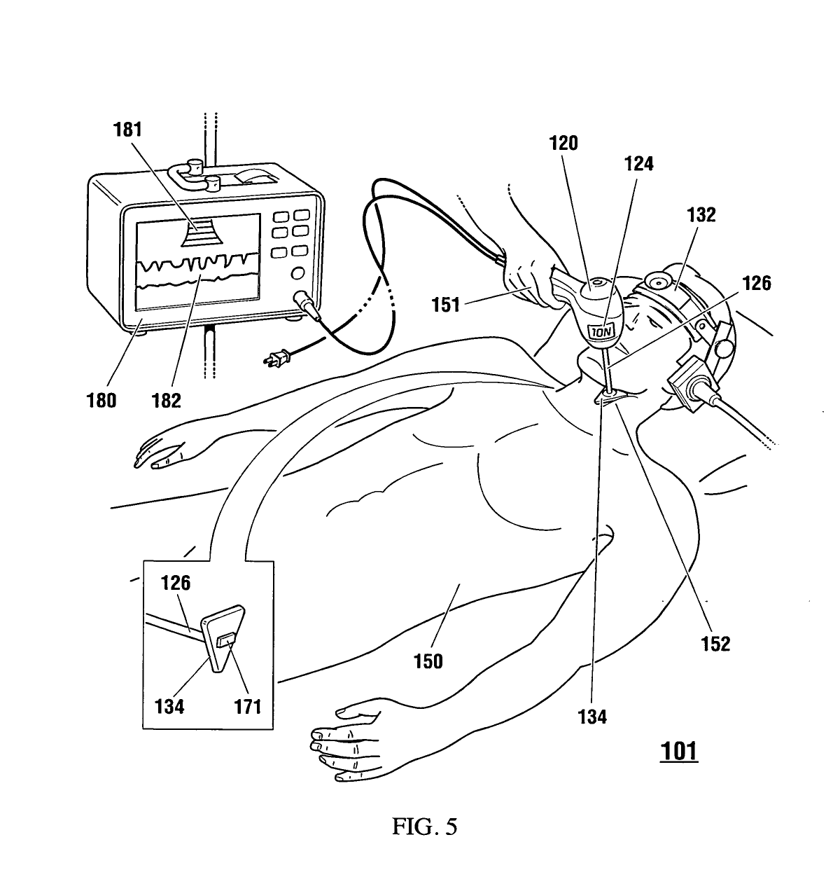

To this end in attention to FIG. 5 a variant, more intelligent second generation SADAR system 101 incorporating ultrasonic imaging for treatment of AIS in supine patient 150 is shown. In this preferred variation vibrator 120 has an alternative percussive ultrasonic imaging contact interface 134 which advantageously disposes an ultrasonic imaging transducer (enabling 3D, 2D, m-mode and Doppler flow imaging via display 180) with ultrasonic transducer engagement face 171 slightly protruding from the center of percussive contact interface 134. Percussive ultrasonic imaging contact interface 134 is operably attached to vibratory shaft 126 and extended from an active end of the reciprocating motor within the housing of vibrator 120 (not shown), such that when the reciprocating motor oscillates percussive ultrasonic imaging contact interface 134 (along with ultrasonic transducer engagement face 171) oscillates, thereby conveying percussion to external body surface 152 as well as concomitant ultrasonic imaging of the structures underlying body surface 152 through an identified acoustic penetration window. Again a digital readout 124 (in this case showing 10 Newtons) is again provided on the housing of vibrator 120 as a visual display so an operator may know how hard he or she is pressing the unit against body surface 152. Imaging of the carotid artery during percussive massage (as shown as vessel 181 on display 180) with the highest level of certainty and accuracy that placement of ultrasonic imaging contact interface 134 upon body surface 152 is perfect during AIS treatment. Furthermore, m-mode analysis of the carotid artery deformations 182 (such as to achieve desired vibration induced carotid deformations of between 10%-30% of the non-provoked carotid arterial vessel diameter) can be substituted as a feedback monitoring means for adequate resulting carotid artery deformations, hence optionally removing the need of finger optical plethysmograph 60 (as shown in FIG. 4) or other bio-feedback sensor. It should be emphasized again that carotid arterial ultrasonic imaging is, a relatively easy skill to learn (i.e. in comparison to cardiac ultrasonic imaging or transcranial imaging), and well within the reach of paramedics or nurses with minimal training.

Regardless of use of “simple” or “imaging assisted” AIS treatment, a clinician or paramedic may note the “side” by which the patient's stroke is afflicted to determine which carotid artery would be of most benefit to be vibrated. For example, if the patient cannot move his or her left side, it is very likely that the stroke involves a brain's anatomic right hemisphere hence application of vibration to the right carotid in this case would be preferred. However, it is preferred to utilize the ultrasonic diagnostic helmet 132 to achieve verification of an acute embolic stroke (including location of the thrombosed cerebral artery), and instructions from the radiologist which carotid if any should thereby be vibrated.

In simple practice the carotid artery will be palpated and then marked with a pen whereby percussive contact interface 133 will be placed, or if imaging assisted AIS treatment is utilized then ultrasonic imaging percussive contact interface 134 will be employed to ensure perfect and maintained positioning over the center of the carotid artery via a minimally skilled approach. However vibrator 120 requires labor intensive hand held placement by operator's of varying confidence and skill level, and only one carotid (per operator) can be treated at a time, so it is generally only recommended in the case where an automated carotid treatment (discussed below) is not available.

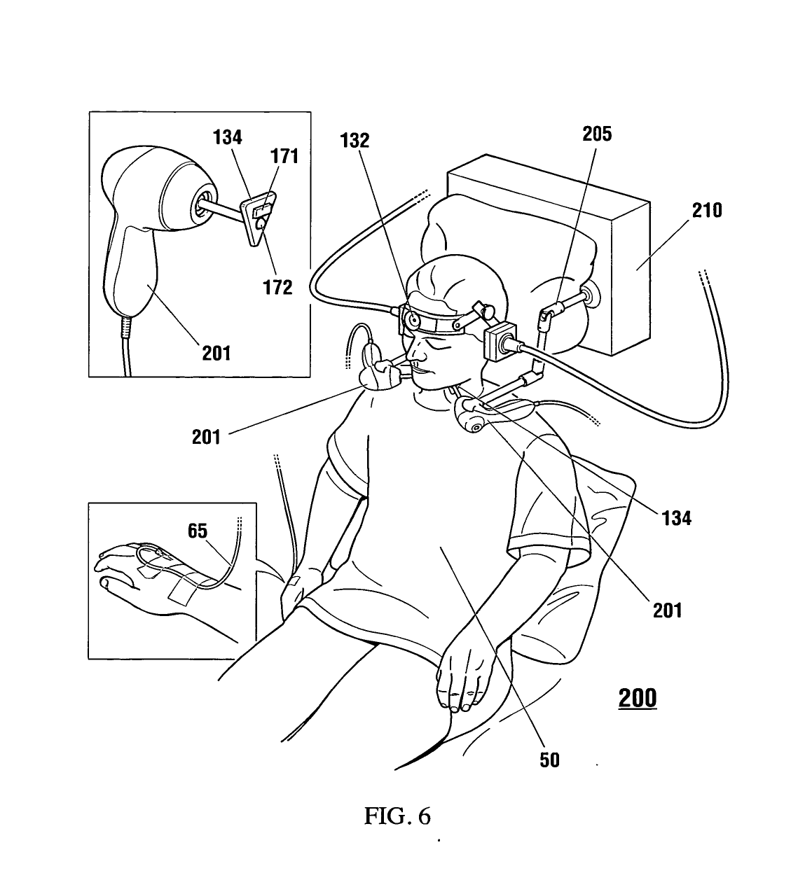

To this end a preferred third generation AIS treatment employs a portable, automated bilateral clamping system 200 as depicted in FIG. 6. Clamping mechanism system 200 is advantageously operable with diagnostic ultrasonic helmet 132, and comprises a pair of robotic arms 205 each which dispose a percussor 201, whereby each percussor 201 enables vibration emissions with selectable frequency, stroke amplitude, wave-shape and wave pattern, including swept frequency mode and the preferred “random” mode which enables randomly varying frequency and wave-shape. Bilateral clamping system 200 is for use in the field, ambulance, emergency room or special procedures unit to enable hands free operation to optionally one or both carotid arteries which thereby increases the overall vibratory, deformative stimulus to the cerebral vasculature by providing simultaneous agitation of acute thrombosis site both antegradely and retrogradely (i.e. from both sides). Percussors 201 each dispose the same triangular shaped percussive ultrasonic imaging contact interface 134 with an ultrasonic engagement face 171 as indicated in SADAR system 101 (see FIG. 5) which thereby enables direct visualization and or in this case computer derived inspection of the carotid artery or arteries, with simultaneous inspection of the flow dynamics within the carotid artery(s), during percussion.

Robotic arms 205 are extended from a pillow like support structure 210 which is mountable from a chair or stretcher (not shown). Following general placement of the patient, bilateral clamping system 200 enables initial automatic locating of the carotid arteries on the neck of patient 50 (who is in this case placed in a seated, semi-reclined position) by a force sensor 172, which senses accelerations of the carotid during pulsations and hence is essentially enabled to “palpate’ the artery and send required positional feedback to robotic arms 205. Ultrasonic imaging guidance via engagement face 171 (disposed alongside force sensor 172 upon ultrasonic imaging contact interface 134 on each of percussors 201) is thereafter utilized to enable automated computer directed maintenance of positioning and engagement force of percussors 201 over their respective carotid artery targets to cause an appropriate level of arterial vessel deformations (i.e. preferably between about 10% to 30%) while ensuring that a safe level of blood flow (inspected by Doppler) is maintained through the carotids during treatment. The system is fully controllable and monitor able by telemetry (such as for use by a radiologist in hospital), and/or by a local operator station (not shown). An IV line 65 is shown to enable administration of thrombolytic drugs, such as Alteplase, and/or IV microbubbles to fully active the SADAR method.

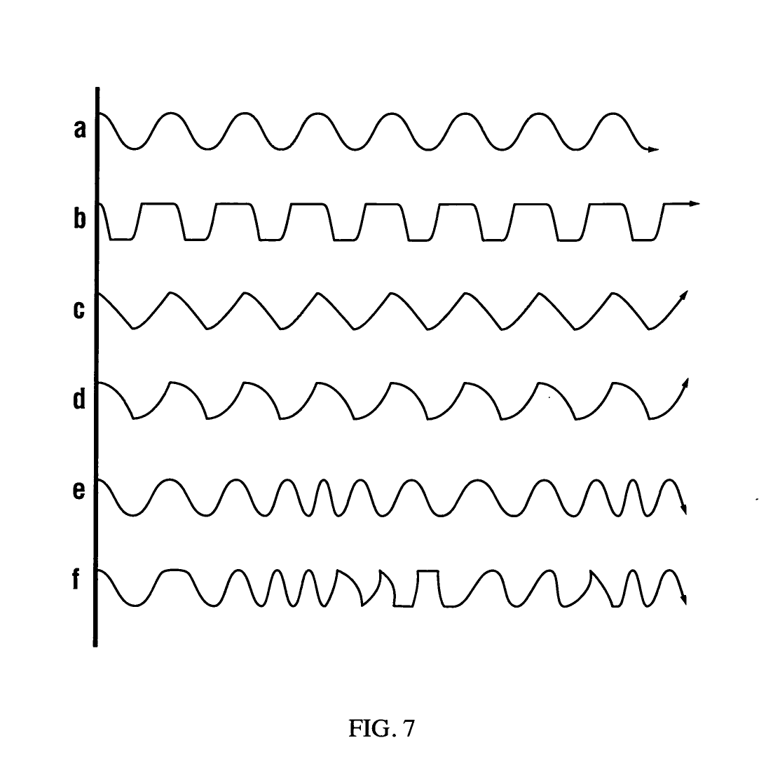

FIG. 7 shows a graphic illustration of a variety of potential vibratory displacement wave forms for use in the SADAR method with time shown on the horizontal axis and mechanical displacement on the vertical axis—including (top to bottom);

(a) sinusoidal (b) percussive impact, or square wave with steep displacement rise, (c) linear (d) exponential or saw-tooth (e) swept or ramped vibration (with varying frequency), and (f) randomic vibration (with at least one of varying frequency and waveform).

The preferred percussive pattern in treatment of STEMI, (particularly if the abdominal aorta or brachial arteries are targeted) is sinusoidal, as the regular and relatively soft accelerating and decelerating nature of the compressions and decompressions on the external body surface are generally more comfortable and hence can be delivered at higher stroke displacement amplitude and/or compression/decompression forces. However, as specified, alternatively any of the other waveforms (saw-tooth, square wave with steep displacement amplitude rise, linear waves, any programmable linear or non-linear wave), including swept or varying randomized modes of vibration delivery (or combinations thereof) may be employed.

The preferred percussive wave pattern in treatment of AIS however (particularly when the carotid artery is targeted) is randomic (where at least one of, and preferably both vibration frequency and wave-shape are varied, preferably randomly varied), as randomized vibration applied to the carotid artery (in relatively close proximity to the thrombosis) will significantly retain its varying chaotic waveform properties and thereby add significant turbulence to the treated culprit cerebral vasculature, particularly at the juncture of the blocked cerebral vessel and the flowing circulation. This, by promoting an ever changing variety of vortices and convection currents (more so than by non-randomized waveforms), will maximize turbulent mixing of systemically delivered thrombolytic, microbubbles, or other helpful medications into the otherwise relatively stagnant, zero flow cerebral vessel. Randomic vibration will also cause agitation of the clot via a variety of differing force vectors (with varying strengths and cadences) hence improving the chances for striking, rocking, jiggling and perturbing the clot in just the right way or combination of ways, (or at an optimal resonance frequency of the clot, or clot/lumen system) to promote with highest efficiency early clot dispersion with recanalization. Randomic vibration comprises but is not limited to at least one of randomized vibration frequency and wave-shape, or combinations thereof.

In view of the above methods and apparatus it is a preferred aspect of the present invention to provide a system or kit, defined by at least two tangible items, whereby the kit enables use of the SADAR method to a paramedic, physician, nurse, physician or other such individual in the field, emergency room, coronary care unit, cardiac catheterization suite or neural special procedures unit.

In one embodiment, the system/kit may comprise a non-invasive vibrator operable to deliver localized, targeted percussion or oscillations to a selected body surface at a serial impact frequency (or compression/decompression frequency) greater than the pulse rate of a patient being treated, (preferably with a serial impact frequency of at least 8 Hz and less than or equal to 1000 Hz, or more preferably 16 Hz or 20 Hz-120 Hz, and most preferably in a range encompassing 50 Hz), and with a stroke displacement amplitude enablement in the 0.1 mm to 100 mm range (preferably 4 mm-15 mm for STEMI cases, and 0.1 mm-6 mm for AIS cases), in combination with a set of instructions or teachings relating to the co-use of an intravenously delivered thrombolytic (or fibrinolytic by other name) drug agent and/or IV microbubbles with such vibrator, whereby the action of the vibrator (which may include any of the particular vibrators or equivalents described in the present invention) synergistically improves the effectiveness of systemically delivered thrombolytic drugs and/or IV microbubbles in providing faster, more timely and complete reperfusion.

The SADAR method improves intravenously or systemically administered thrombolytic drug (and/or IV microbubble) effectiveness by the following pair of mechanisms. First, SADAR increases intra-arterial turbulence at the thrombosis site (as well as at the juncture of the blocked vessel and flowing circulation) thereby increasing mixing, or active diffusion of systemically introduced drugs into the otherwise zero flow acutely thrombosed artery. Second, SADAR promotes clot erosion and fluid channel development alongside and within a culprit clot, thereby allowing early flow of systemically introduced medicants (including thrombolytics) into the acutely thrombosed artery and facilitating lytic exposure to increased fibrin binding sites. Essentially, the SADAR method acts as a mechanism for enhanced drug delivery of thrombolytics and/or microbubbles from the systemic circulation into the thrombosed artery requiring treatment.

It is preferred to also include within the system/kit a feedback monitoring means enabling determination of hemodynamic fluctuations induced by a vibrator (e.g. such as with finger optical plethysmograph 60, but any similarly effective monitoring means as described to the invention may be used), such as to ensure the vibrator is well placed and seated against a target artery to cause propagating blood pressure/flow fluctuations needed to reach a culprit thrombosed artery to assist in clearance of the vessel. Most preferably the system/kit would also physically include a thrombolytic drug agent and/or IV acoustically active microbubbles (beyond the instructions) to expedite use of the kit, as well as of course instructions for use of the feed back monitoring apparatus with the vibrator.

It should be emphasized however that the SADAR method does not absolutely require use of thrombolytic drug agents, in that proper use of a vibrator (preferably with feedback monitoring sensor) as a stand-alone procedure, or along with less powerful clot disrupting agents (e.g. heparin, antiplatelets etc.), or in combination with ultrasonically active IV microbubbles, can also be helpful in restoring reperfusion of an acutely thrombosed artery. Furthermore, it should also be emphasized that while co-use of a feedback monitoring system (e.g. force sensor finger optical plethysmograph 60) is very helpful and definitely optimizes correct use of engagement force and positioning of and upon a vibrator to ensure therapeutic levels of propagating blood pressure fluctuations within the blood stream are occurring, a vibrator may still be utilized in accordance to the SADAR technique without such a feedback monitoring system. A target artery may for example simply be located relative to an external skin surface by known anatomic reference or by palpation, with a prescribed use of frequency, stroke displacement amplitude and engagement force applied by the vibrator whereby therapeutic propagating oscillations are thereafter (albeit with some inaccuracy) assumed.

In another embodiment of the invention, the system/kit may alternatively comprise a thrombolytic (or fibrinolytic by other name) drug agent, or IV microbubbles, along with instructions relating to the SADAR method via use of a suitable non-invasive vibrator or percussion device (with or without monitoring feedback sensors) for treatment of STEMI or AIS. To expedite delivery of the SADAR method, the system/kit may also physically include a vibrator (of any type named within the scope of the present invention, plus there reasonable equivalents) and/or feedback sensor or sensors (also disclosed to the present invention, plus there functional equivalents), to optimize the kit for use.

It should also be pointed out that it is possible (although definitely not preferred) to use a thrombolytic drug agent without a percussion device in practice of the SADAR method, in that manual percussions delivered by hand (or hands) of a therapist could potentially be applied, such as at the lower frequency ranges (e.g. 8 percussions per second). Percussion—via drum-roll karate chops—for example could be employed by a therapist against the neck (i.e. generally over the carotid artery) or arm (over the brachial artery) of a patient along with an administration of a thromboloytic drug agent. Further, the abdomen or lower back (overlying the abdominal aorta) could be aggressively oscillated by a double handed technique (palms down) where the right and left hand of a therapist rapidly alternate inward and outward oscillations. However this may not be advisable in most situations for safety reasons—and the course and uncontrolled nature of the percussion could lead to bruising on the patient and undue fatigue to the therapist.

Instructions or teachings (whether for use of a vibrator co-jointly with a thrombolytic and/or microbubbles, or vice versa a thrombolytic and/or microbubbles co-jointly with a vibrator), may be in many forms (paper slip or manual, interne article, audio instruction, verbal explanations from a sales or clinical support representative etc.), and would preferably reside in easy access to (or co-ordinated with) an operator of the thrombolytic and/or microbubble, and/or vibrator, and would convey all the methods and apparatus described within this present disclosure (including use of feedback sensors enabling detection of arterial vessel deformations or resultant blood flow or pressure fluctuations to enable optimized vibrator positioning), to enable many levels of assisted drug effectiveness or drug delivery, depending on the skill or comfort level of an operator.

The tangible constituents of the system/kit may vary (i.e. vibrator plus instructions in co-use of a thrombolytic with or without microbubbles) or (thrombolytic and/or microbubbles plus instructions for co-use of a vibrator), or (vibrator plus thrombolytic or microbubbles) or (vibrator plus thrombolytic, with or without microbubbles, plus instructions in the joint use) or (vibrator plus instructions of co-use of microbubbles and/or thromboytics with monitoring feed back sensor) or (vibrator and monitoring feedback sensor) or (monitoring feedback sensor with instructions for co-use with a vibrator) or (vibrator, monitoring feedback sensor and thrombolytic drug agent and/or microbubbles), or (thrombolytic and/or microbubbles with instructions in use of vibrator with monitoring feedback sensor), and most preferably (vibrator plus thrombolytic, plus microbubbles, plus monitoring feedback sensor, plus instructions of their co-joint use).

In summary, the steps for treatment of an acutely thrombosed artery (regardless of STEMI, AIS, or even acute pulmonary embolus) by the SADAR system can be summarized as follows,
a) select a major, preferably superficial-palpable, accessible target artery (or more broadly target blood vessel—as the target could in rare circumstance comprise a vein, discussed later) which underlies relatively soft, deformable or at least moveable tissue, said blood vessel being preferably as proximate as possible (baring safety issues) to the acutely thrombosed artery requiring treatment and preferably residing within a body part extending from the torso (such as the neck or limbs) of the patient to be treated,
b) palpate the position of the target artery or blood vessel (if possible) or assume the artery's or blood vessel's position based on anatomic reference, or image the artery or blood vessel directly by means of ultrasonic imaging, to determine a vibratory target site upon an external body surface generally overlying the target artery or blood vessel,
c) place the contact interface of a selected vibrator locally upon the target site which generally overlies the major target artery or blood vessel,
d) select prescribed stroke amplitude and engagement force (or alternating pressure) to the vibrator against the target site while applying vibration at a frequency greater than the patient's heart rate, and preferably in the high infrasonic to low sonic frequency range via a to and fro motion from the contact interface to compress and decompress the target site (at any time prior to termination of (c), *note, the engagement force may be varied according to articulations from the patient from time to time, if the application is too uncomfortable etc.
e) confirm vibration induced artery vessel deformations and/or blood pressure or flow fluctuations are being adequately propagated (and preferably maximized) by hemodynamic assessment of a measurable artery distant from the vibrated artery or blood vessel, whereby the distance from the vibrated artery to the measured artery should preferably be similar or greater than the distance from the vibrated artery to the acutely thrombosed artery, or by assessing the degree of vessel deformation occurring at the target artery or blood vessel directly,
f) modify at least one of vibrator engagement force against the patient's body surface, or stroke amplitude emission, or vibration wave-shape or emission pattern, or position or direction of the vibrator relative to the patient's body surface according to biofeedback data obtained in step (e), during the course of therapy, and
g) continue applying vibration via said vibrator for 20 minutes or until evidence of reperfusion of the acutely thrombosed artery is confirmed (either by images derived by an ultrasonic imaging head fixture such as in the Duke brain helmet in AIS treatment, or by reduction of ST segment elevation by greater than or equal to 50% in STEMI treatment) where after vibration will either be continued for a select period of time at a reduced stroke displacement amplitude or terminated upon the advisement of a physician. Note, onset of an intra-cerebral bleed will indicate immediate termination of vibro-percussion.

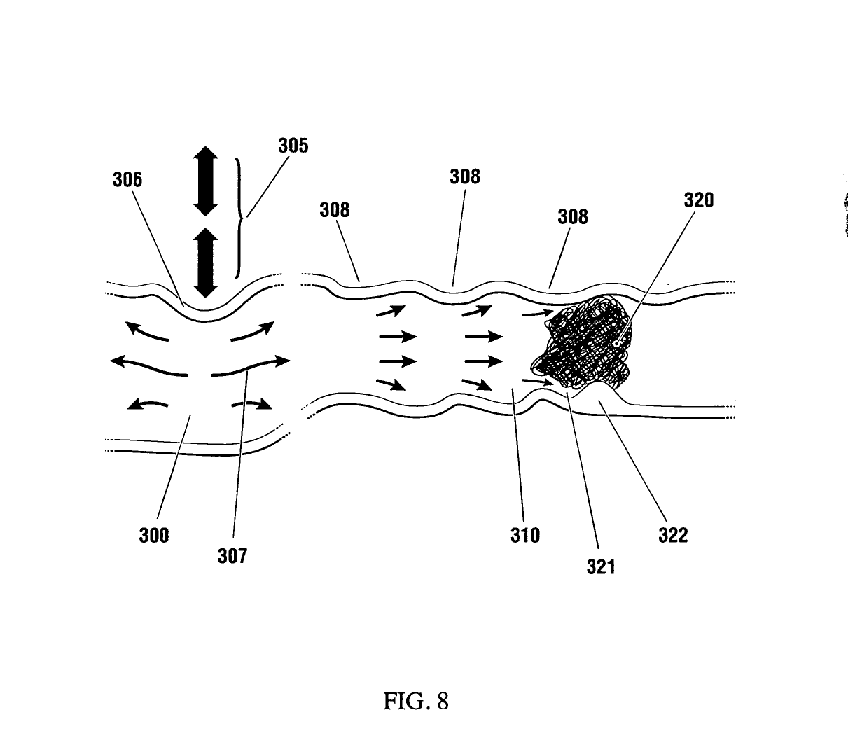

In attention to FIG. 8., the physiologic theory behind the SADAR method is diagrammed. Remote, relatively large target artery 300 (such as the brachial artery in STEMI cases or the carotid artery in AIS cases) is locally deformed by serial mechanical reciprocating percussions (or compressions and decompressions) 305 to cause a series of vessel deformations 306 which result in a battery of blood pressure pulses and a corresponding wave train of vessel deformations (shown by force vectors 307 moving left to right with corresponding vessel deformations 308 propagated along the artery) which propagate towards a relatively smaller acutely thrombosed artery 310 to strike and agitate clot 320 therein. A non-uniform force distribution strikes the leading surface of clot 320 inducing shear stresses and causing deformation of the clot lengthwise (parallel to the vessel lumen), while localized vessel deformations at the clot interface deform the clot width wise (perpendicular to the vessel lumen). This causes erosion of the young aggregation of platelets formed at the surface of clot 320 with a corresponding development of fluid channels such as shown at site 321 adjacent to the clot within the arterial lumen to enhance early flow, as well increasing the likelihood of detachment and distal mobilization of clot 320 from its luminal stenosis site 322 which assists early reflow of the major epicardial or cerebral vessel. Furthermore the vibration waves transmitted along the vessel walls to the acute thrombosis site will tend to induce relaxation of arterial spasm (not shown in FIG. 8) which is commonly associated within acutely thrombosed coronary arteries (in at least 50% of cases), thereby offering the potential for immediate, or near immediate reflow in many STEMI patients. Moreover, a high degree of turbulence is initiated in the blood stream proximate the acute thrombosed artery helping in drug delivery from the systemic circulation to clot 320 even in absence of flow.

There are many variations with regards to the proposed SADAR technique, both for STEMI and AIS treatment.

Firstly, while percussion is preferably directed towards the brachial artery(s) in STEMI treatment (with a preferred lower frequency selection in the 8 Hz-120 Hz range at high compressive and decompressive engagement forces of the vibrator pressed against the patient, other target arteries which reside similarly close to the skin surface may alternatively be used in the SADAR method of STEMI treatment (e.g. in some individuals the innominate artery, and while generally not advised for safety reasons when thrombolytics are used—the carotid artery—or because the artery is non-preferably remote from the heart—the iliac or femoral artery).

Also, regardless of the target artery chosen in the SADAR technique, while higher stroke amplitudes (within safety limits) in the low sonic ranges are still preferred to maximize the resulting agitative disruptive hemodynamic effects reaching the coronaries, as the target arteries are so superficial and easy to non-invasively deform potentially lower displacement amplitudes (e.g. 0.1 mm-1 mm) with lower engagement forces (e.g. 5-8 N) and higher frequency emissions (up to or just less than 1000 Hz) could be contemplated and are hence included in the scope of the present invention.

Similarly while percussion of the carotid artery is preferred in AIS treatment, any other artery within the neck (including the internal or external carotid) or other more remote arteries may be targeted for percussion (e.g. the brachial artery(s)—whereby the arm(s) is/are vibrated—, the innominate artery—whereby the base of the neck is vibrated—and less preferably the abdominal aorta, iliac or femoral arteries—whereby the lower back/abdomen or upper leg to groin area is vibrated respectively) may be considered in practice of SADAR therapy.

It should also be noted, while this specification indicates use of SADAR technology to assist reperfusion in life-threatening conditions such STEMI or AIS, alternatively the SADAR system could also be utilized for treatment of acute pulmonary embolus (particularly Saddle Embolus—where the entire pulmonary artery is acutely thrombosed or blocked—a particularly dangerous situation with a poor prognosis), whereby application of vibration or percussion at an impact frequency greater than a patient's heart rate, and preferably in the high infrasonic to low sonic frequency range (as indicated to the invention) to the arm via the methods shown in FIG. 3 (to serial compress and decompress the brachial vein(s)), or neck via the methods shown in FIG. 4, 5 or 6 (although in this case to vibrate a Jugular Vein), or lower back or abdomen (although in this case to vibrate the Inferior Vena Cavae) could be employed, whereby the vibrations and pressure pulses (including blood flow and blood volume fluctuations—all together hemodynamic fluctuations) instigated within the blood vessels of the great veins would propagate to the right side of the heart and then to the pulmonary artery to assist in reperfusion. The pulmonary artery (like the coronary arteries) is also contained within the rigid, bone supported body surfaces of the thoracic cavity, hence the SADAR method as above described to assist reperfusion is particularly indicated. This technique—in treatment of pulmonary embolus—should be used with extreme caution as vibration of a culprit great vein may promote further mobilization of more unwanted clots towards the right side of the heart. An IV line should of course be included to enable delivery of thrombolytic drug agents (with or without IV microbubbles), to properly enable the SADAR method for treatment of acute pulmonary embolus, and in particular life threatening Saddle Embolus.

Secondly, while the preferred engagement means for a vibrator in STEMI treatment when the abdominal aorta is considered as the target artery is the hands of an operator, alternatively other engagement means such as a clamp or tighten able belt upon the lower back or abdomen of the patient (to place and engage vibrator 20 or a smaller equivalent vibrator, towards the brachial artery or abdominal aorta for example) to enable hand free percussion delivery, with transient supervision of an attending paramedic may alternatively be used. Exemplary illustrations of such engagement means (although shown in application to a patient's chest wall—but could be simply moved downwards to be place-able upon the lower torso) have been provided earlier within the patent family of this present application (see U.S. patent Ser. No. 10/902,122), which is herein incorporated by reference.

Alternatively, regardless of whether the SADAR treatment is directed towards STEMI or AIS, an inflatable bladder or bladders (or a tightenable belt or sleeve) with each system disposing a mechanical vibro-percussion unit (such as vibrator 20 or 120) may be used to enable hands free engagement, whereby constant inflation of the bladder (or appropriate tightening of the belt or sleeve—preferably to a pressure just greater than the diastolic pressure of a patent being treated) placed around a limb or limbs of a patient (such as preferably the upper arm (s) to deform the brachial artery—being in closer proximity to the heart or brain—but the leg(s) could also be used—to apply serial deformations to femoral artery(s)) is employed to hold a vibrator in place against a focal percussion site directly proximate or overlying the target artery to be deformed.

It is also possible in STEMI treatment to combine remotely delivered SADAR therapy with chest wall diastolic timed percussion such as offer able by the Diastolic Time Vibrator (DTV) system disclosed within the patent family of this present application which have been herein incorporated by reference in their entirety.

Transthoracically applied diastolic timed percussion (or serial percussion periodically halted during at least the early to mid force generating periods of the left ventricular in systole) applied to the chest wall (or upper back in a variation) leads to improved diastolic function of the ischemic left ventricle which increases pump function in ischemic conditions (by the Frank Starling mechanism), which thereby augments coronary perfusion pressure and is known to enhance coronary flow which would be very instrumental in assisting reperfusion (especially when a patient's blood pressure is diminished, such as in cardiogenic shock). Diastolic transthoracic vibro-percussion will also assist in the relaxation of the smooth muscles within the commonly spasming coronary vasculature (which occurs in at least 50% of cases in STEMI according to the literature), by causing a local release of nitric oxide—which is a potent vasodilator—and by directly massaging the vessel walls to assist in decoupling of the actin-myosin filaments of the sarcomere of the smooth muscle fiber, which would also assist in early reflow. Moreover, transthoracic percussion creates a degree of turbulence in the proximal ascending aorta and otherwise zero flow thrombosed coronary vessel which assist in intravenously delivered thrombolytic drug delivery (by facilitating diffusive mixing), and would also assist in providing increased fluid action with sheer stresses and clot erosion within the culprit vessel to effect superior reperfusion.

However as the thoracic cavity is resistant to deformative displacement by externally delivered forces, the DTV is suboptimal at actually serially compressing and decompressing the proximal ascending thoracic aorta or coronary vessels within the thoracic cavity to provide marked blood pressure fluctuations within the thrombosed vasculature which greatly enhance clearance of acute thrombosis. SADAR vibration to the brachial arteries or other superficial accessible artery on the other hand would enhance what the DTV does sub-optimally, in providing a rapid battery of propagating pressure pulses which would attack, agitate and push the acute thrombosis distally to encourage clot erosion with subsequent accelerated clearance of the major acutely thrombosed epicardial vessel. Hence the two technologies (DTV and SADAR) placed in tandem together could provide a very robust, highly efficient non-invasive reperfusion system, preferably administrable with intravenously delivered thrombolytic drug therapy with or without IV microbubbles, for treatment of STEMI, and is herein included as a variation according to the invention.

Thirdly with regards to selection of a bio-feedback monitoring sensor enabling detection of and degree of percussion or oscillation induced target artery deformations with resultant propagating blood pressure fluctuations (to ensure optimized positioning, engagement or compression force, stroke amplitude emissions, and optionally wave-shape and wave pattern emissions) of a non-invasive vibrator positioned over a target artery), instead of the preferred optical finger plethysmograph 60 (which shows serial blood volume changes arising from arterial blood flow to a finger), alternatively other types of plethysmographs (to detect arterial blood volume changes in other arteries and body parts distant from the directly percussed artery) could be used, such as an electrical impedance plethysmograph or a pneumo-plethysmograph.

Also, instead of or in combination with plethysmography a Doppler ultrasonic transducer may also be applied to a measurable artery distant from the targeted artery to detect blood flow fluctuations (arising from blood pressure fluctuations) which directly relate to the quality and degree of target artery vessel deformations, and the transmission thereof. As yet a further alternate (usable alone, or in combination with the above), an ultrasonic transducer enabling m-mode acquisition may be equivalently applied upon any of the same measurable arteries distant from the directly percussed targeted artery to detect propagated arterial vessel deformations (relating to the real time diameter changes of the lumen of measurable arteries), which may be shown on an ultrasonic imaging m-mode display.

In yet another possibility, an accelerometer or force sensor may also be applied to a measurable artery remote from the directly oscillated artery, either as a stand alone method or in combination with the above sensors, whereby arterial deformations moving towards and away from the force (or accelerometer) sensor are transmitted to the skin surface over which the sensor is deployed which can thereby be detected.

More details with regards to potential use of a force sensor or accelerometer are herein provided for sake of illustration only in attention to FIG. 1. A high frequency force sensor may be advantageously applied upon the left carotid artery (not shown) of patient 50, for assessment of vessel deformations within the carotid artery (resulting from propagating blood pressure and flow fluctuations from the abdominal aorta) conforming to the selected frequency emissions as established by accelerometer 25, to confirm and guide correct positioning and a required selection of engagement force of vibrator 20 upon body surface 52. When the force sensor detects carotid arterial vessel deformations a light (not shown) upon vibrator head 23 may illuminate green (one light for minimal amplitude transmission, two lights for good, moderate amplitude transmission and three lights for excellent high amplitude transmission), thereby informing the operator that positioning and engagement force upon vibrator 20 is satisfactory or optimized. The force sensor may be optionally, and advantageously accompanied by control force sensor or an array of force sensors which is/are disposed to an external body surface of the neck remote from a pulsatile artery (this done to assist in cancelation of vibration “noise” in assessment of vibratory deformations of the carotid artery, which may have transmitted to a small degree from body surface 52 to the outer surfaces of the neck of patient 50). The array of force sensors would be preferred to increase sensitivity of detection of carotid arterial deformation pulses and to improve noise cancelling capability.

Indeed, the exact nature of the sensor in detecting the quality and degree of arterial deformations and/or resulting blood pressure fluctuations is not critical to the operation of the SADAR system, and hence any known sensor which enables detection of arterial vessel deformations or vessel diameter changes, or resultant blood pressure fluctuations (or resultant blood flow or volume fluctuations), can be used according to the invention. If a hand held controlled engagement approach was utilized, an operator would alter the position and/or engagement or compression force of the vibrator (such as applied over the selected target artery), and/or adjust the stroke amplitude (or oscillating compression/decompression strength) and optionally wave shape or pattern emissions of the vibrator, to establish the greatest corresponding signals possible which may be either heard via an audio presentation, or shown on an a display screen. If a hands free oscillating bladder system was utilized as opposed to, or in co-ordination with a hands on approach, the same principles would apply, although the device positioning would not be a significant factor.

It should also be explained that there is no absolute maximum stroke displacement amplitude or engagement force (or compression pressure) which may be employed to deliver percussion in use of the SADAR method, as the limit is highly dependent on the nature of the patient (i.e. the patient's weight and tolerance levels in receiving percussive massage), and the percussive application site. A maximum force delivered by percussion or serial oscillations would be the subject of local or federal guidelines determined following adoption of the SADAR system, although it is generally not recommended to cause complete vessel collapse of the carotid artery in treatment of AIS. Also, while the present invention describes the use of a variety of potential vibratory displacement waveforms and vibratory emission patterns (e.g. sinusoidal, square or percussive wave, saw-tooth wave, linear wave, sweeped frequency and randomly applied vibration (with at least one of varying wave-shapes and frequency), as the linear stepper motor within vibrator 20 or 120, as well as the oscillative motor which drives limb bladders 80 is programmable, virtually any type of vibration waveform—linear or nonlinear, may be used in accordance to the invention.

As will be apparent to those skilled in the art in light of the foregoing disclosure, many additional alterations and modifications are possible in the practice of this invention without departing from the spirit or scope thereof. Accordingly, the scope the invention is to be construed in accordance with the substance and specific wording defined by the following claims.

What is claimed is:

1) A non-invasive emergency method to assist clearance of an acutely thrombosed artery residing within a substantially bone supported body cavity having external body surfaces resistant to mechanically induced displacement relative to said acutely thrombosed artery, comprising the steps of
a) placing a vibrator locally proximate a target blood vessel remote from said bone supported cavity, said target blood vessel having at least one overlying, boneless external body surface susceptible to mechanically induced displacement relative to said target blood vessel, and
b) applying localized mechanical vibration via said vibrator targeted towards said target blood vessel to repeatedly compress said target blood vessel at any time prior to termination of step (a), said vibration having a serial impact frequency greater than the pulse rate of a patient being treated by said vibrator, with a stroke displacement amplitude of at least 0.1 mm,
whereby said vibration causes significant vessel deformations of said target blood vessel, thereby enabling a rapid battery of consecutive hemodynamic fluctuations to be propagated towards said acutely thrombosed artery from said target blood vessel, to assist in clearance of said acutely thrombosed artery.

2) The method of claim 1, whereby said vibrator is operable to deliver oscillations at a serial impact frequency of at least 8 impacts per second and less than 1000 impacts per second.

3) The method of claim 2, whereby said vibrator delivers percussion at a serial impact frequency of at least 16 Hz.

4) The method of claim 1, whereby said vibrator delivers vibrations at a frequency in the range of 20 Hz to 120 Hz.

5) The method of claim 1; whereby said vibrator emits oscillations at a frequency within a range encompassing 50 Hz.

6) The method of claim 1, wherein said target blood vessel resides within a body part extending from the torso and being palpably close to the skin surface of a patient being treated by said vibrator.

7) The method of claim 2, wherein said acutely thrombosed artery is an acutely thrombosed coronary artery, whereby said bone supported body cavity surrounding said acutely thrombosed coronary artery comprises the thoracic cavity, and wherein said acutely thrombosed coronary artery results in a diagnosis of ST elevation myocardial infarction.

8) The method of claim 2, wherein said acutely thrombosed artery is an acutely thrombosed cerebral artery, whereby said bone supported body cavity containing said cerebral artery comprises the cranial cavity, and wherein said acutely thrombosed cerebral artery results in a diagnosis of acute ischemic stroke.

9) The method of claim 2, wherein said acutely thrombosed artery is a pulmonary artery, whereby said boney supported body cavity containing said pulmonary artery comprises the thoracic cavity, and wherein said acutely thrombosed pulmonary artery results in a diagnosis of at least one of a pulmonary embolus and saddle embolus.

10) The method of claim 7, wherein said vibrator is applied to the lower back of a patient being treated by said vibration.

11) The method of claim 7, whereby said vibrator is operable to deliver a stroke amplitude of at least 1 mm, to ensure adequate vessel deformation of said target blood vessel.

12) The method of claim 8, whereby said vibrator is operable to deliver a stroke displacement amplitude in the range of 0.1 mm to 6 mm.

13) The method of claim 2, wherein said vibrator is enabled to emit an oscillative wave form comprising at least one of a sinusoidal wave, an exponential or saw tooth wave, a square wave with a steep displacement amplitude rise, a linear wave, a non-linear wave, and combinations thereof.

14) The method of claim 1, wherein said vibrator emits swept oscillations across a predetermined frequency range.

15) The method of claim 2, wherein said vibrator is enabled to emit varied oscillations, wherein at least one of oscillation frequency and waveform is varied during emission of said vibration.

16) The method of claim 1, wherein said vibrator has a percussive contact interface comprising an ultrasonic transducer enabling at least one of 2D, 3D, 4D, m-mode and doppler interrogation, thereby enabling direct localization of said target blood vessel during said percussion through an identified acoustic window, to ensure optimized placement of said vibrator upon said target blood vessel.

17) The method of claim 1, wherein said vibrator is held upon a carotid artery of a patient being treated by said vibrator by a robotic arm.

18) The method of claim 2, wherein said vibrator is placed proximate a brachial artery upon the arm of a patient being treated by said vibrator.

19) The method of claim 18, wherein said vibrator comprises a high frequency bladder, whereby said vibration is achieved through rapid inflation and deflation of said bladder.

20) The vibrator of claim 8, wherein said vibrator is placed to directly overly a carotid artery upon the neck of a patient being treated by said vibrator.

21) The method of claim 1, wherein said target blood vessel is a target artery, and comprising the additional step of administering a non-invasive sensor for determining a degree of arterial vessel deformations of said target artery induced as a result of said vibration, such as to enable an adjustment of vibrator related parameters to optimize delivery of said vibration.

22) The method of claim 21 wherein said sensor comprises at least one of a force sensor, a force sensor in combination with a force control sensor, an accelerometer, and accelerometer in combination with an accelerometer control sensor, a pneumo-plethysmograph, an optical plethysmograph, an impedence plethysmography, a doppler flow meter, and combinations thereof, whereby said sensor is non-invasively placed proximate a remote artery distant from said target artery, thereby enabling assessment of, in the case of said force sensors and said accelerometers deformations of said remote artery caused by propagating blood pressure fluctuations arising from said target artery, in the case of said plethysmographs propagating blood volume changes within a measured body part resulting from arterial flow fluctuations arising from said target artery, and in the case of said doppler flow meter propagating blood flow changes arising from said target artery.

23) The method of claim 21, wherein said sensor comprises a transducer enabling m-mode acquisition, whereby said transducer is placed upon at least one of said target artery to enable detection of vessel deformations directly within said target artery, and a measurable artery distant from said target artery to enable detection of arterial vessel deformations within said measurable artery induced by vessel deformations propagated from said target artery.

24) The method of claim 1, wherein said vibration is delivered at any time with respect to the cardiac cycle of said patient being treated by said vibrator.

25) The method of claim 2, wherein the administration of said vibration is periodically halted during at least part of the systole of the cardiac cycle of a patient being treated by said vibrator.

26) The method of claim 25, wherein said vibration is periodically halted in accordance to recognition of a P-Q complex of an electrocardiogram.

27) The method of claim 25, wherein said vibration is halted by an active breaking system acting on a motor responsible for generating said vibration, said breaking system comprising at least one of a reversal of electrical polarity and a piezoelectric break.

28) The method of claim 8, whereby said vibrator has a percussive contact interface sized and shaped to enable seating within the carotid triangle of said patient receiving therapy from said vibrator, whereby said percussive contact interface has at least one contact surface dimension equal to or greater than 7 mm to ensure adequate coverage of said percussive contact interface over said carotid artery.

29) The method of claim 8, further comprising the step of diagnosing an acute ischemic stroke via an ultrasonic imaging head fixture prior to beginning said vibration, whereby said vibration is initiated in at least one of an ambulance, in the field, and in-hospital.

30) The method of claim 8, further comprising the step of diagnosing reperfusion of said acutely thrombosed cerebral artery via an ultrasonic imaging head fixture, and then administering at least one of a reduced stroke displacement amplitude and termination of said vibration as a result of said diagnosing reperfusion of said acutely thrombosed cerebral artery.

31) The method of claim 1, whereby said vibrator is administered to said external body surface by a hand held technique.

32) The method of claim 1 comprising the additional step of applying non-invasive transthoracic percussion in combination with said vibration applied to said target blood vessel remote from said bone supported cavity in treatment of an acutely thrombosed coronary artery, said percussion periodically halted during at least part of the systole of the cardiac cycle of said patient, whereby said percussion and said vibration work together to optimize reperfusion of said acutely thrombosed coronary artery.

33) The method of claim 1, further comprising the step of intravenously administering a thrombolytic drug at any point prior to termination of said vibration, whereby said vibration enhances the effectiveness of said thrombolytic drug in clearing said acutely thrombosed artery.

34) The method of claim 2, further comprising the step of intravenously administering intravenous microbubbles at any point prior to termination of said vibration, whereby said vibration enhances the effectiveness of said microbubbles in clearing said acutely thrombosed artery.

35) A system for assisting reperfusion of an acutely thrombosed artery comprising,
a) a non-invasive vibrator operable to deliver mechanical oscillations at a frequency greater than the pulse rate of a patient being treated by said vibrator with a stroke amplitude of at least 0.1 mm, and
b) instructions, which teach or express the contents of claim 1
whereby said instructions enable an operator to use said vibrator in treatment of said acutely thrombosed artery.

36) The system of claim 35, further comprising instructions, which teach or express the contents of claim 2.

37) The system of claim 35, further comprising instructions, which teach or express the contents of claim 3.

38) The system of claim 35, further comprising instructions, which teach or express the contents of claim 4

39) A system for assisting thrombolytic drug effectiveness in treatment of at least one of a heart attack, acute ischemic stroke and pulmonary embolus comprising,
a) a set of instructions comprising or expressing the contents of claim 1 and
b) a thrombolytic drug co-ordinated with said instructions,
whereby an operator armed with said instructions and said thrombolytic drug is thereby enabled to administer therapeutic vibration adjunctive to intravenously injected thrombolytic drug therapy to assist in clearance of an acutely thromobsed artery responsible for said heart attack or acute ischemic stroke or pulmonary embolus.

40) The system of claim 39, further comprising instructions comprising or expressing the contents of claim 2.

41) The system of claim 39, further comprising instructions comprising or expressing the contents of claim 4.

42) A non-invasive method for treating an acute ischemic stroke comprising the steps of,
a) positioning a percussion device upon an external body surface directly overlying an artery within the neck of a patient experiencing said acute ischemic stroke, and
b) applying oscillations at a serial impact frequency greater than the heart rate of said patient at a stroke amplitude of at least 0.1 mm via said percussion device upon said external body surface at any time prior to completion of step (a),
whereby consecutive vessel deformations of said artery within the neck resulting from said oscillations cause a battery of propagating hemodynamic fluctuations which assist clearance of an acutely thrombosed cerebral artery remote from said carotid artery in remediation of said acute ischemic stroke.

43) The non-invasive method of claim 43, wherein said artery within the neck comprises a carotid artery.

44) A non-invasive method for treating an ST elevation myocardial infarction comprising the steps of
a) positioning a vibrator locally upon an external body surface deemed to overly a non-invasively palpable target artery remote from an acutely thrombosed coronary artery of a patient experiencing said ST elevation myocardial infarction,
b) delivering localized mechanical oscillations at a frequency in the range of at least 8 Hz and less than 1000 Hz upon said external body surface towards said palpable target artery via said vibrator at any time prior to completion of step (a), to cause localized compressions and decompressions of said target artery.
whereby serial vessel deformations of said target artery remote from said acutely thrombosed coronary artery cause a battery of propagating hemodynamic fluctuations towards said acutely thrombosed coronary artery which assist clearance of said acutely thrombosed coronary artery.

45) The non-invasive method as indicated in claim 39, wherein said palpable target artery comprises a brachial artery.
